(19) United States
(12) Patent Application Publication
(10) Pub. No.: US 2010/0293193 A1
(43) Pub. Date: Nov. 18, 2010

(54) DOCUMENT GEOSPATIAL SHAPE TAGGING, SEARCHING, ARCHIVING, AND RETRIEVAL SOFTWARE

(75) Inventors: Craig D. Harrison, Fort Collins, CO (US); Brian R. Funk, Johnstown, CO (US)

Correspondence Address: COCHRAN FREUND & YOUNG LLC, 2026 CARIBOU DR, SUITE 201, FORT COLLINS, CO, 80525, US

(73) Assignee: LANDNET CORPORATION, Loveland, CO (US)

(21) Appl. No.: 12/844,652

(22) Filed: Jul. 27, 2010

Related U.S. Application Data
(62) Division of application No. 11/383,729, filed on May 16, 2006.
Application No. 11/383,729 is a continuation-in-part of application No. 11/339,267, filed on Jan. 24, 2006, now Pat. No. 7,356,406.
Application No. 11/339,267 is a continuation of application No. 10/365,718, filed on Feb. 11, 2003, now Pat. No. 7,054,741.
Application No. 11/339,267 is a continuation-in-part of application No. 10/162,723, filed on Jun. 3, 2002, now Pat. No. 7,171,389.
(60) Provisional application No. 60/356,405, filed on Feb. 11, 2002.
(60) Provisional application No. 60/295,097, filed on Jun. 1, 2001.
(60) Provisional application No. 60/336,258, filed on Oct. 31, 2001.
(60) Provisional application No. 60/370,083, filed on Apr. 4, 2002.
(60) Provisional application No. 60/356,405, filed on Feb. 11, 2002.

(51) Int. Cl. G06F 17/30

(52) U.S. Cl. 707/769; 707/E17.009

(57) ABSTRACT

Disclosed is a document geospatial tagging, searching, archiving, and retrieval software system. The software system includes a tool that tags electronic documents with a geospatial tag. The geospatial tag indicates the shape and the geospatial points, in order, that define the location and extent of the geospatial location associated with an electronic document. Each point in the geospatial tag may be comprised of an X coordinate value, a Y coordinate value, an elevation/height value, and a date and time value. Electronic documents may be tagged manually by the user, automatically by the software application creating the document, or via a tagging search engine that searches files for geospatial location data and then tags each file with the results of the search. Once the electronic documents have been geospatially tagged, a search engine may search a network, either an intranet or the Internet, in order to locate electronic documents associated with a user desired geospatial location. After electronic documents associated with a desired geospatial location have been found and retrieved, the electronic documents may be stored on an archival storage system for future use. The documents may also be moved to a different electronic storage device/location for easy access by the user. The documents may also be sorted according to different aspects of the geospatial tag linked to each document. Different types of sorts are possible using the geospatial data contained in the geospatial tag, including: sorting by size of the geospatial area, sorting by elevation/height values, date and time values, and the type of shape of the geospatial area.

### CROSS REFERENCE TO RELATED APPLICATIONS

This application is a divisional application of U.S. patent application Ser. No. 11/383,729, entitled “A Document Geospatial Shape Tagging, Searching, Archiving and Retrieval Software,” filed May 16, 2006, which application is a continuation-in-part of U.S. patent application Ser. No. 11/339,267, entitled “Land Software Tool,” filed on Jan. 24, 2006, which application is a continuation of U.S. patent application Ser. No. 10/365,718, entitled “Land Software Tool,” filed on Feb. 11, 2003, which was based upon and claims the benefit of U.S. provisional application Ser. No. 60/356,405, filed Feb. 11, 2002, entitled “An Internet Delivered and Accessible Set of Maps, Images, and Tools for Locating, Identifying, Measuring, Viewing, and Communicating Information about Land and Areas of Land” and U.S. patent application Ser. No. 10/162,723, entitled “Identification, Storage and Display of Land Data on a Website,” filed Jun. 3, 2002, which application was based upon and claims the benefit of U.S. provisional patent application Ser. No. 60/295,097, filed Jun. 1, 2001, entitled “Identification, Storage and Display of Land Data on a Website,” U.S. provisional patent application Ser. No. 60/336,258, filed Oct. 31, 2001, entitled “Identification, Storage and Display of Land Data on a Website,” U.S. provisional patent application Ser. No. 60/370,083, filed Apr. 4, 2002, entitled “Web Imaging Server Technology,” and U.S. provisional patent application Ser. No. 60/356,405, filed Feb. 11, 2002, entitled “An Internet Delivered and Accessible Set of Maps, Images, and Tools for Locating, Identifying, Measuring, Viewing, and Communicating About Land and Areas of Land.” The entire contents of each referenced patent application and provisional patent application are hereby specifically incorporated by reference for all they disclose and teach.

### BACKGROUND OF THE INVENTION

Many real estate developers and potential real estate buyers wish to perform due diligence on land. The due diligence involves a check of the monetary values, ownership, geography, local amenities, and other pertinent features of a piece of real estate. Often, important data and features of the piece of real estate may be found in a variety of documents, such as: title abstracts, deed information, legal descriptions, leases, rights-of-way, surveys, watershed studies, easements, loan information, appraisal reports, grazing leases, insurance, conservation easements, ownership rights, public land leases, maps, ground based photography, and aerial photography, etc.

An embodiment may therefore comprise a method of marking electronic files to assist in searching files based on geospatial location data comprising: identifying an electronic file; determining a geospatial location associated with the electronic file; storing the geospatial location data of the geospatial location in a geospatial tag, the geospatial tag delineating the geospatial location using at least two elements, a shape element and a geospatial coordinate element, the shape element defining the shape of the geospatial location, and the geospatial coordinate element defining the geospatial coordinates of the geospatial location; and linking the geospatial tag with the electronic file.

Another embodiment may comprise a software application that marks electronic files to assist in file searches based on geospatial location data comprising: an identification subsystem that identifies an electronic file and determines a geospatial location associated with the electronic file; and a storage and link subsystem that stores the geospatial location data of the geospatial location in a geospatial tag and link the geospatial tag with the electronic file, the geospatial tag delineating the geospatial location using at least two elements, a shape element and a geospatial coordinate element, the shape element defining the shape of the geospatial location, and the geospatial coordinate element defining the geospatial coordinates of the geospatial location.

Another embodiment may comprise a method of searching electronic files comprising: obtaining geospatial location data relating to a location of interest; converting the geospatial location data into a range of geospatial coordinate search points; searching geospatial tags linked with the electronic files for the range of geospatial coordinate search points, the geospatial tags storing geospatial shape data for each of the electronic files linked to each of the geospatial tags, each of the geospatial tags delineating a geospatial shape associated with each of the electronic files using at least two elements, a shape element and a geospatial coordinate element, the shape element defining the shape of the geospatial shape data, and the geospatial coordinate element defining the geospatial coordinates of the geospatial shape data; identifying found electronic files, the found electronic files being a subset of the electronic files wherein the geospatial tags linked to the electronic files contain at least one geospatial coordinate search point of the range of geospatial coordinate search points; retrieving the found electronic files; and delivering the found electronic files to a user.

Another embodiment may comprise a search engine that searches electronic files comprising: a geospatial location subsystem that obtains geospatial location data relating to a location of interest and converts the geospatial location data relating to the location of interest into a range of geospatial coordinate search points; a search subsystem that searches geospatial tags linked with the electronic files for the range geospatial coordinate search points and identifies found electronic files, the found electronic files being a subset of the electronic files, wherein the geospatial tags linked to the electronic files contain at least one geospatial coordinate search point of the range of geospatial coordinate search points, each of the geospatial tags delineating geospatial shape data associated with each of the electronic files using at least two elements, a shape element and a geospatial coordinate element, the shape element defining the shape of the geospatial shape data, and the geospatial coordinate element defining the geospatial coordinates of the geospatial shape data; and a retrieval and delivery subsystem that retrieves the found electronic files and delivers the found electronic files to a user.

Another embodiment may comprise a software application that marks electronic files to assist in file searches based on geospatial location data comprising: means for identifying an electronic file; means for determining a geospatial location associated with the electronic file; means for storing the geospatial location data of the geospatial location in a geospatial tag; and means for linking the geospatial tag with the electronic file.

Another embodiment may comprise a search engine that searches electronic files comprising: means for obtaining geospatial location data relating to a location of interest; means for converting the geospatial location data into a range of geospatial coordinate search points; means for searching geospatial tags linked with the electronic files for the range of geospatial coordinate search points; means for identifying found electronic files; means for retrieving the found electronic files; and means for delivering the found electronic files to a user.

### BRIEF DESCRIPTION OF THE DRAWINGS

FIG. 1 is a schematic illustration of the basic geospatial tag architecture.

FIG. 2 is a schematic illustration of the geospatial tag architecture including a tagging mechanism.

FIG. 3 is a schematic illustration of the geospatial tag architecture including a tagging mechanism and a searching mechanism.

FIG. 4 is a schematic illustration of the structure of an electronic file with geospatial data stored in a tag header portion of the electronic file.

FIG. 5 is a schematic illustration of the structure of an electronic file with geospatial data stored in a linked geospatial tag file.

FIG. 6 is a schematic illustration of the structure of electronic files with geospatial data stored in a tag database or tag list.

FIG. 7 is a schematic illustration of the data structure of a geospatial tag.

FIG. 8 is a schematic illustration of the data structure of a geospatial coordinate point contained within a geospatial tag.

FIG. 9 is a schematic illustration of the points necessary to define the extent of a point shape.

FIG. 10 is a schematic illustration of the points necessary to define the extent of a line shape with a single line segment.

FIG. 11 is a schematic illustration of the points necessary to define the extent of a line shape with multiple line segments.

FIG. 12 is a schematic illustration of the points necessary to define the extent of an open arc shape.

FIG. 13 is a schematic illustration of the points necessary to define the extent of a polygon shape making a triangle.

FIG. 14 is a schematic illustration of the points necessary to define the extent of a polygon shape.

FIG. 15 is a schematic illustration of the points necessary to define the extent of a circle shape.

FIG. 16 is a schematic illustration of the points necessary to define the extent of an oval shape.

FIG. 17 is a schematic illustration of the points necessary to define the extent of a closed arc shape.

FIG. 18 is a flow chart describing the steps of a manual geospatial file tagging mechanism.

FIG. 19 is a flow chart describing the steps of an automatic geospatial file tagging mechanism.

FIG. 20 is a flow chart describing the steps of a search engine based automatic geospatial file tagging mechanism.

FIG. 21 is a flow chart describing the steps of a geospatial tag based searching mechanism using a manually entered geospatial location as the basis for the search.

FIG. 22 is a flow chart describing the steps of a geospatial tag based searching mechanism using a geospatial location defined by a border drawing tool as the basis for the search.

FIG. 23 is a schematic illustration of a variety of geospatial tags found for a specific search area.

FIG. 24 is a schematic illustration of geospatial tags found for a search area enclosed within the area described by the geospatial tag.

FIG. 25 is a schematic illustration of the geospatial tags found for a point search area.

FIG. 26 is a schematic illustration of a geospatial tag implementing multiple shapes using breaks for pen up/pen down functionality.

### DETAILED DESCRIPTION OF THE INVENTION

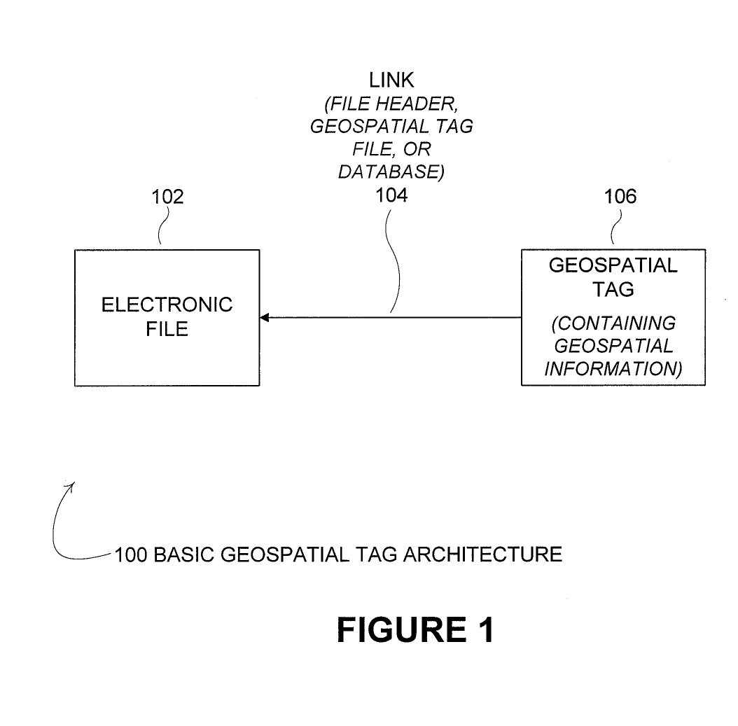

FIG. 1 is a schematic illustration of the basic geospatial tag architecture 100. An electronic file 102 may be associated with a geospatial location in a variety of ways. The electronic file 102 may reference a geospatial location as part of the body of the file 102. Every electronic file 102 is related to at least one geospatial location, even if the associated geospatial location is just the location of where the file 102 was created. Typically, an electronic file 102 does not have a means to quickly ascertain any geospatial location data that may be associated with the file 102. In order to locate electronic documents (e-documents) associated with a specific geospatial location, it is often necessary to open each document and scan the document to find any references to geospatial locations. If the associated geospatial location is not part of the body of the electronic file 102, the data may not be available if the data is not stored at the time of file 102 creation. For a variety of reasons, tracking the geospatial location(s) associated with an electronic file 102 may be beneficial.

An embodiment 100 associates the electronic file 102 to a geospatial location by linking 104 the electronic file 102 with a geospatial tag 106. The geospatial tag 104, contains the geospatial data associated with the electronic file 102. The link 104 between the geospatial tag 106 and the electronic file 102 may be implemented in many ways, including: attaching the geospatial tag 106 to the electronic file 102 in a header portion of the electronic file 102, associating a separate geospatial tag file with the electronic file 102, and keeping a database or other list of the geospatial tags 106 associated with electronic files 102. For all types of geospatial tags 106, the geospatial tag 106 contains the geospatial location data associated with the electronic file 102. If the file 102 is associated with more than one geospatial location, it is also possible to use multiple geospatial tags 106 for a single electronic file 102. Alternatively, it is also possible to place multiple shapes into a single geospatial tag 106.

With the widespread use of computers, more and more documents are being created as electronic documents. Many older, paper documents are also being scanned and stored as electronic documents. With many documents stored in electronic form, linking 104 each document with an associated geospatial location may make document searches more efficient. The use of electronic documents to perform due diligence on real estate is a good example of a beneficial association 104 of an electronic file 102 with a geospatial location 106. Performing due diligence on real estate requires a person to gather all of the documents related to a piece of property. If each document is tagged 104 with a geospatial location 106, it becomes easier to find the documents 102 associated with the real estate under investigation. Another use of geospatial tags 106 for files 102 may be to locate the origin of creation or modifications for electronic files 102. No matter what the end use may be, linking 102 geospatial tags 106 with electronic files 102 may be beneficial.

The electronic documents may consist of many types of documents. Examples of contract and pre-closing documents include, but are not limited to: Letter of Intent, Contract to Buy and Sell Real Estate, Agreement to Amend/Extend, Contract Assignment, Contract Addenda, Lead-Based Paint Disclosure, Inspection Notice, Brokerage Disclosure, Seller's Property Disclosure, Counterproposal, and Earnest Money Promissory Note documents. Examples of conveyance documents include, but are not limited to: General/Special Warranty Deeds, Quit Claim Deeds, Bill of Sale, Water Stock Assignments, Mineral Deed, Water Tap Transfers, and Well Permit Transfer documents. Examples of loan documents include, but are not limited to: Deed of Trust, Promissory Note, UCC Financing Statements, Security Agreement, and Credit Report documents. Examples of title and survey documents include, but are not limited to: Title Insurance Commitment, ALTA/ACSM Land Title Survey, Tax Certificate, Closing Instructions, Statement of Settlement, Real Property Transfer Declaration, Forms DR-1083, Agreement for Taxes, Utility Agreement, Closing Confirmation for 1099 Reporting, Title Insurance Owner's Policy, Title Insurance Lender's Policy documents. Examples of organization and authority documents include, but are not limited to: Articles of Organization, By-Laws, Operating Agreement, Certificate of Good Standing, Resolutions/Unanimous Consents, and Power of Attorney (Real Estate) documents. Examples of due diligence documents include, but are not limited to: Architectural Drawings, As-Built Building Plans, Building Inspection, Compliance Checks, Constraints Analysis, Construction Design Documents, Endangered Species Reports, Existing Deed of Trust, Geology Studies, Guarantees/Warrantees, Hydrology Studies, Land Plans, Leases, Market Feasibility Studies, Mining Reports, Oil and Gas Leases, Permits and Licenses, Personal Property Inventory, Phase 1 Environmental Studies, Phase 2 Environmental Studies, Property Insurance, Service and Maintenance Contracts, Sketch Plans, Soils Reports, Traffic Studies, Utilities, Wetlands Studies, Wildlife Studies, Zoning Maps, and Zoning Regulations

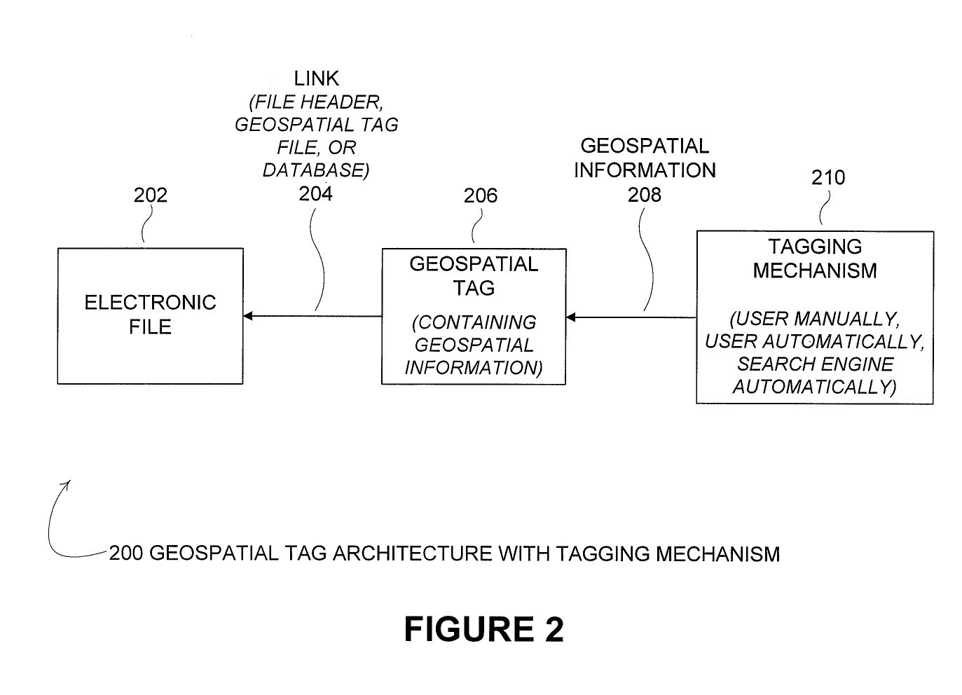

FIG. 2 is a schematic illustration 200 of the geospatial tag architecture including a tagging mechanism 210. An embodiment 200 associates the electronic file 202 to a geospatial location 208 by linking 204 the electronic file 202 with a geospatial tag 206. The geospatial tag 204, contains the geospatial information 208 associated with the electronic file 202. The link 204 between the geospatial tag 206 and the electronic file 202 may be implemented in many ways, including: attaching the geospatial tag 206 to the electronic file 202 in a header portion of the electronic file 202, associating a separate geospatial tag file with the electronic file 202, and keeping a database or other list of the geospatial tags 206 associated with electronic files 202. For all types of geospatial tags 206, the geospatial tag 206 contains the geospatial location data 208 associated with the electronic file 202. If the file 202 is associated with more than one geospatial location 208, it is also possible to use multiple geospatial tags 206 for a single electronic file 202.

The geospatial location information 208 for the electronic file 202 may be obtained through a tagging mechanism 210. The tagging mechanism 210 may gather the geospatial information 208 associated with the electronic file 202 in many different ways, including: a user manually creating the geospatial information 208 for the geospatial tag 206 and linking 204 the geospatial tag to the electronic file 202; a user creating the electronic file 202 and automatically creating the geospatial tag 206 with geospatial information 208 using software working in cooperation with the software that created the electronic file; and a search engine that checks the body of the electronic file 202 to locate geospatial information 208, creates a geospatial tag 206 holding the geospatial information 208, and then links 204 the geospatial tag 206 to the electronic file 202.

To manually create the geographic tag 206, the user may use a software tool to define the geographic location information 208. The software tool may be a system such as the land software tool, including various boundary/shape creation and drawing tools, as disclosed in the cross-referenced U.S. patent application Ser. No. 11/339,267, entitled “Land Software Tool,” filed on Jan. 24, 2006 by Craig D. Harrison and James J. Graham. The land software tool may include the ability to automatically create the geospatial tag 206 holding the geospatial information 208 defined by the user and linked 204 via the geospatial tag 206 to the electronic file 202. A geospatial shape may be defined by boundaries, thus a boundary may be thought of as a geospatial shape.

When the tagging mechanism 210 is implemented using a search engine, the tagging mechanism 210 may also search a network to locate electronic files 202 to find the geospatial location information 208. The network searched may be any computer network, including a private intranet or the public Internet.

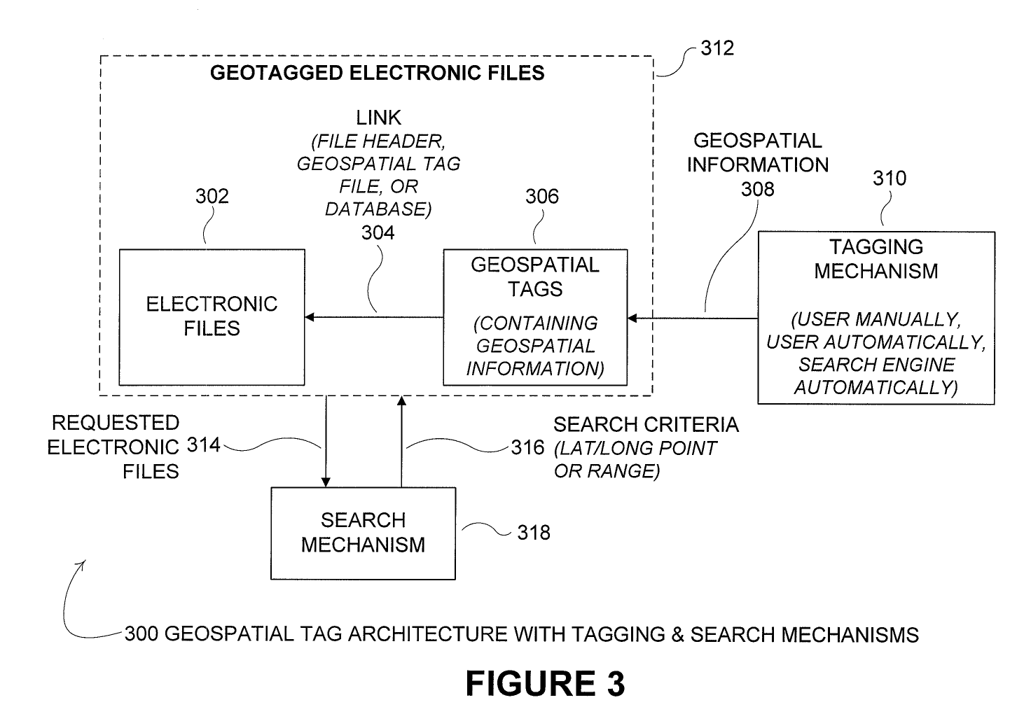

FIG. 3 is a schematic illustration 300 of the geospatial tag architecture including a tagging mechanism 310 and a searching mechanism 318. An embodiment 300 associates the electronic file 302 to a geospatial location 308 by linking 304 the electronic file 302 with a geospatial tag 306. The geospatial tag 304, contains the geospatial information 308 associated with the electronic file 302. The link 304 between the geospatial tag 306 and the electronic file 302 may be implemented in many ways, including: attaching the geospatial tag 306 to the electronic file 302 in a header portion of the electronic file 302, associating a separate geospatial tag file with the electronic file 302, and keeping a database or other list of the geospatial tags 306 associated with electronic files 302. For all types of geospatial tags 306, the geospatial tag 306 contains the geospatial location data 308 associated with the electronic file 302. If the file 302 is associated with more than one geospatial location 308, it is also possible to use multiple geospatial tags 306 for a single electronic file 302. Alternatively, it may also be possible to store multiple shapes in a single geospatial tag 306.

The geospatial location information 308 for the electronic file 302 may be obtained through a tagging mechanism 310. The tagging mechanism 310 may gather the geospatial information 308 associated with the electronic file 302 in many different ways, including: a user manually creating the geospatial information 308 for the geospatial tag 306 and linking 304 the geospatial tag to the electronic file 302; a user creating the electronic file 302 and automatically creating the geospatial tag 306 with geospatial information 308 using software working in cooperation with the software that created the electronic file; and a search engine that checks the body of the electronic file 302 to locate geospatial information 308, creates a geospatial tag 306 holding the geospatial information 308, and then links 304 the geospatial tag 306 to the electronic file 302.

To manually create the geographic tag 306, the user may use a software tool to define the geospatial location information 308. The software tool may be a system such as the land software tool, including various boundary/shape creation and drawing tools, as disclosed in the cross-referenced U.S. patent application Ser. No. 11/339,267, entitled “Land Software Tool,” filed on Jan. 24, 2006 by Craig D. Harrison and James J. Graham. The land software tool may include the ability to automatically create the geospatial tag 306 holding the geospatial information 308 defined by the user and linked 304 via the geospatial tag 306 to the electronic file 302.

When the tagging mechanism 310 is implemented using a search engine, the tagging mechanism 310 may also search a network to locate electronic files 302, before opening the electronic files 302, to find the geospatial location information 308. The network searched may be any computer network, including a private intranet or the public Internet.

After the tagging mechanism 310 has linked 304 geospatial tags 306 with one or more electronic files 302, there exists a group of geotagged electronic files 312. The geotagged electronic files 312 may exist on either, or both, private intranet or a public Internet computer networks. A search mechanism 318 may be used to find and retrieve geotagged electronic files 312. The search mechanism 318 would use search criteria 316 to limit the number of geotagged files 312 retrieved as a group of requested electronic files 314. The search criteria 316 of the search mechanism 318 contains geospatial location information, such as a latitude/longitude point or a range of latitude/longitude coordinates. The range of latitude/longitude coordinates may encompass shapes in the same fashion as is done with the geospatial tag. The search mechanism 318 searches the geotagged electronic files 312 and retrieves 314 only the electronic files 302 linked 304 to geographic tags 306 that overlap or equal the search criteria 316.

The search mechanism 318 may obtain the geospatial information for the search criteria 316 using a software tool. The software tool may be a system such as the land software tool, including various boundary/shape creation and drawing tools, as disclosed in the cross-referenced U.S. patent application Ser. No. 11/339,267, entitled “Land Software Tool,” filed on Jan. 24, 2006 by Craig D. Harrison and James J. Graham. The land software tool may include the search mechanism 318 as an integrated part of the land software tool, allowing a user to seamlessly create a boundary/shape on a map or image and obtain all requested electronic files 314 associated with the boundary/shape. A geospatial shape may be defined by boundaries, thus a boundary may be thought of as a geospatial shape.

The search mechanism 318 may also include other file management capabilities. The search mechanism 318 may permit the user to store the requested electronic files 314 in a permanent archival storage system. The user may also be permitted to move and/or copy the requested electronic files 314 to a desired electronic storage location where the requested electronic files 314 may be manipulated by the user without affecting the original copy of the requested electronic files 314. The search mechanism 318 may also sort the requested electronic files 314 in numerous ways to facilitate the user organizing the requested electronic files 314 and/or locating specific files within the group of requested electronic files 314. The search mechanism may sort on any aspect of the geospatial tags 306 linked 304 to the electronic files 302, including the size of an area defined by the geospatial tags 306, the date and time defined by the geospatial tags 306, the elevation/height defined by the geospatial tags 306, or the type of shape of the geospatial tags 306. Multiple elements of geospatial information held in the geospatial tags 306 may be sorted in a single sorting operation.

The search mechanism 318 has the benefit of gathering all of the requested electronic files 314 associated with specific geospatial information of the search criteria 316 into one location. Once the requested electronic files 314 are found, the requested files 314 may be managed and manipulated as a group. Thus, an embodiment enables a user to easily and quickly locate and operate on a group of electronic files 314 associated with specific geospatial information, as defined in the search criteria 316. The ability to locate and operate on a group of files is especially useful for users performing due diligence for real estate transactions, but the functionality may be used for any purpose that associates a file with geospatial location information.

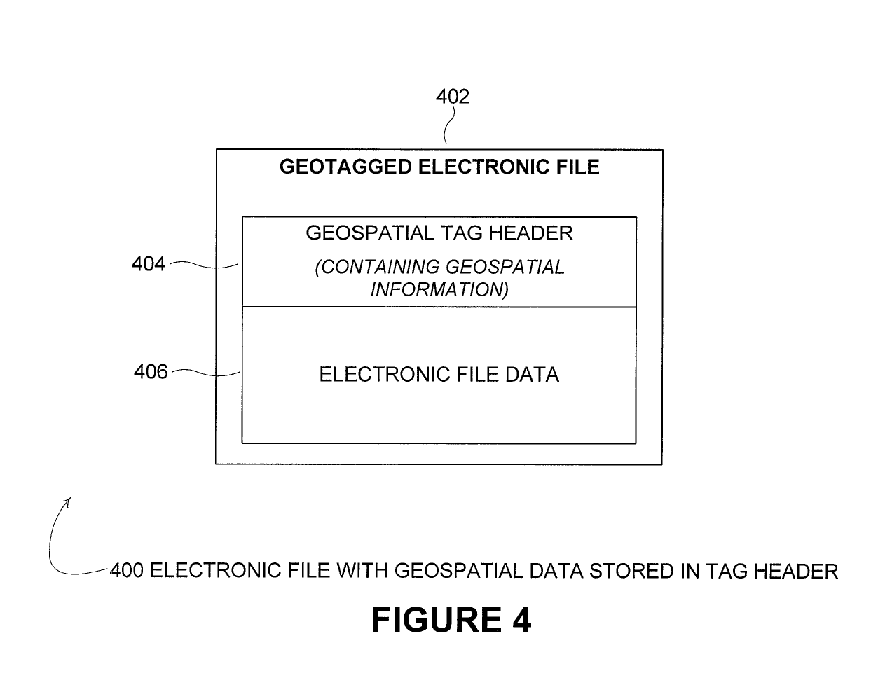

FIG. 4 is a schematic illustration 400 of the structure of an electronic file 402 with geospatial data stored in a tag header portion 404 of the electronic file 402. The geospatial tag 404 may be linked with the geotagged electronic file 402 by including the geospatial tag 404 within the geotagged electronic file 402. The geospatial tag 404 may be included as part of the header 404 information for the geotagged electronic file 404. The geospatial tag header 404 may be appended at the beginning, the end, or any other designated location in relation to the electronic file data 406 of the body of the geotagged file 402. Thus, the geotagged electronic file 402 would consist of the geospatial tag header 404 and the electronic file data 406 of the body of the geotagged file 402.

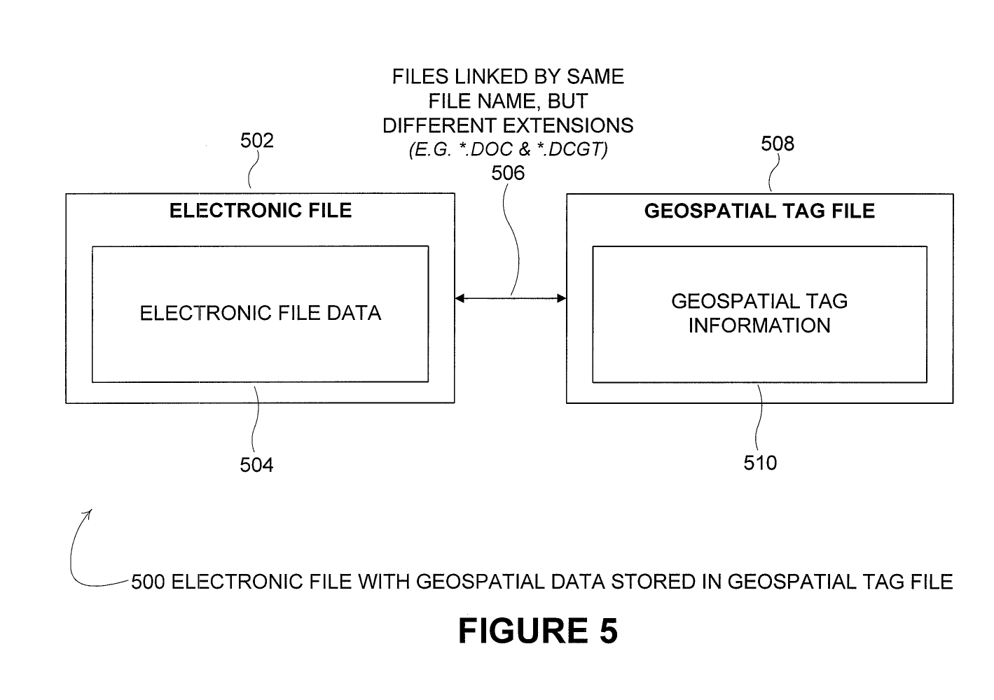

FIG. 5 is a schematic illustration 500 of the structure of an electronic file 502 with geospatial data 510 stored in a linked 506 geospatial tag file 508. An embodiment may link 506 an electronic file 502 with geospatial tag information 510 using a geospatial tag file 508. The link 506 is accomplished by giving the geospatial tag file 508 the same file name as the electronic file 502, but giving the geospatial tag file 508 a different file name extension than the electronic file 502. The file name extension is the file type indication appended to the end of a file name common to computer file naming conventions. For instance, a Microsoft Word document is indicated with the file extension of “.doc.” For the case of the Microsoft Word document, the linked 506 geospatial document might be indicated by a file extension of “.dcgt,” indicating a document (dc) geospatial tag (gt) file. A search mechanism would be able to recognize that the electronic file 502 is linked 506 to the geospatial tag file 508 by locating the geospatial tag file 508 with a geospatial tag file extension 506 and the same file name as the electronic file 502. Thus, the electronic file 502 would not need to be modified in order to be linked 506 to the geospatial tag 508, and the electronic file 502 would contain only the original electronic file data 504 contained in the electronic file 502 prior to being linked 506 to the geospatial tag 508.

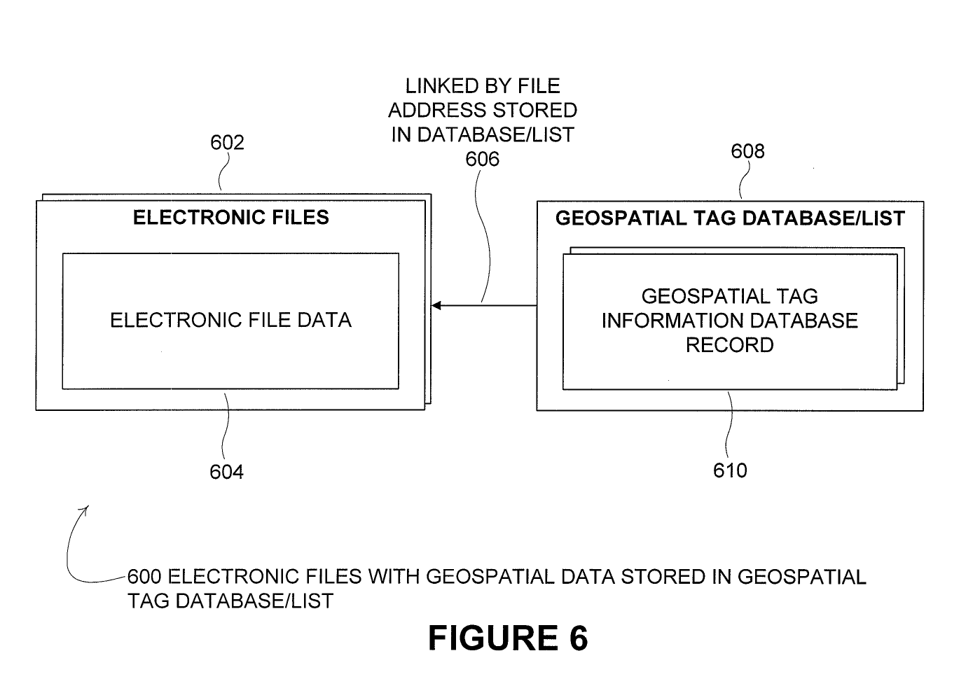

FIG. 6 is a schematic illustration 600 of the structure of electronic files 602 with geospatial data 610 stored in a tag database or tag list 608. An embodiment may link 606 an electronic file 602 with geospatial information contained in a geospatial tag 610 using a geospatial tag database or list 608. A geospatial tag list 608 may be created such that the list 608 contains an entry for geospatial tag information 610 and a reference 606 to an electronic file linked 606 to the geospatial information 610. Using a geospatial tag list 608, the electronic file 602 would not need to be modified in order to be linked 606 to the geospatial tag 610, and the electronic file 602 would contain only the original electronic file data 604 contained in the electronic file 602 prior to being linked 606 to the geospatial tag 610.

A common method to create a geospatial tag list 608 is to put the list 608 into a database. The geospatial tag database 608 may include records for each geospatial tag 610 such that the geospatial tag record 610 includes a reference to the linked 606 electronic file 602. Other database implementations may also be used to create the geospatial tag list 608. For instance, three database tables may be created such that one table contains a list of all electronic files 602, a second list contains a list of all geospatial tags 610, and a third list maintains a correlation between the electronic file 602 list and the geospatial tag 610 list. Using a database with three lists permits the database to store data about the electronic files 602 and the geospatial tags 610 one time while permitting each electronic file 602 to be linked 606 to multiple geospatial tags 610. Similarly, each geospatial tag 610 may be linked 606 to multiple electronic files 602. Computer databases and list structures may be created in a large number of configurations and an embodiment may use whichever database or list structure a system designer deems to best meet the requirement of linking 606 the electronic files 602 to the associated geospatial tags 610.

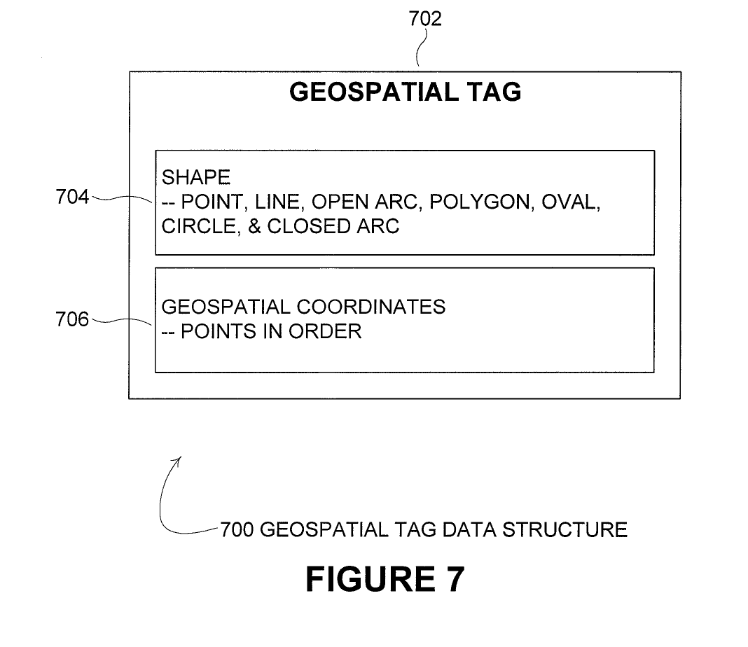

FIG. 7 is a schematic illustration of the data structure 700 of a geospatial tag 702. The geospatial tag 702 may utilize any data structure that permits the geospatial tag 702 to hold geospatial data. An embodiment 700 of a geospatial tag 702 data structure may consist of two elements, a shape element 704, and a geospatial coordinate element 706. The shape element 704 holds the type of shape that the geospatial tag 702 is delineating. Some examples of possible shape types for the shape element 704 of a geospatial tag 702 include, but are not limited to: a point, a line (including lines consisting of multiple line segments), an open arc, a polygon, an oval, a circle, and a closed arc. Some of the shapes include the enclosed area of the shape, such as the polygon, oval, circle, and closed arc. Other shapes include only the connecting lines, such as the line and open arc. The point shape includes only a single point. It is also possible to combine different shape types into a new “multi” shape type. For instance a multi-shape element might consist of numerous line segments with some open arcs included between line segments. Another example is including an arc in the definition of a polygon.

The geospatial coordinate element 706 consists of the geospatial coordinates for each point needed to define the extent of the shape type designated in the shape element 704. Typically each geospatial point would be listed in the order necessary to define the extent of the shape named in the shape element 704. Each geospatial point includes a reference to a geographic coordinate location, and, possibly, additional information such as an elevation/height value and/or a date and time value.

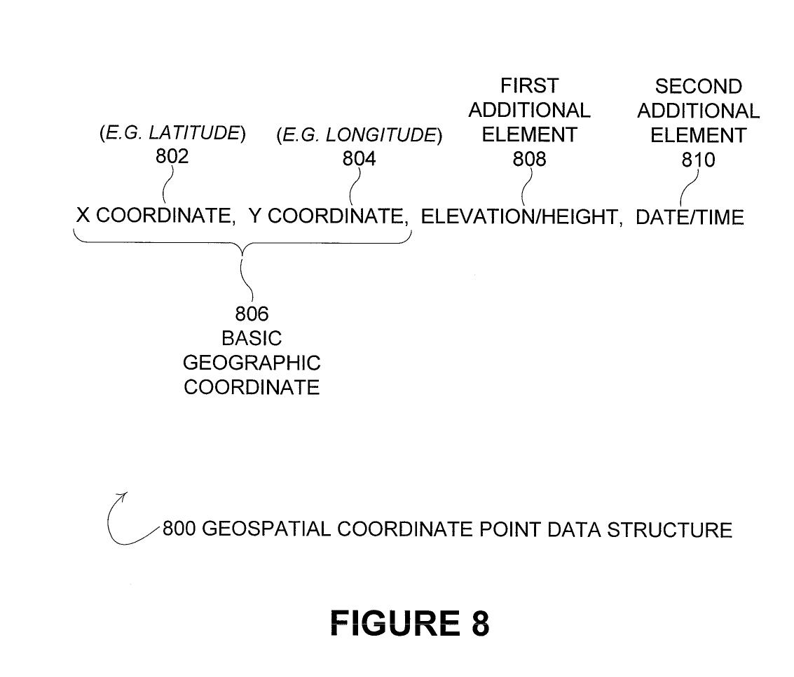

FIG. 8 is a schematic illustration of the data structure of a geospatial coordinate point contained within a geospatial tag 800. A geospatial point data structure 800 consists of a basic geographic coordinate 806. The basic geographic coordinate consists of an X coordinate 802 and a Y coordinate 804. The X 802 and Y 804 coordinates are defined in a geographic coordinate system. Common geographic coordinate systems include latitude/longitude and Universal Transverse Mercator (UTM). For the latitude/longitude coordinate system the X coordinate 802 may contain the latitude value and the Y coordinate 804 may contain the longitude value.

Additional elements may be included in the geospatial point data structure 800, as necessary to index geospatially tagged files. Some additional elements might include an elevation or height value 808 or a date and time value 810. The elevation/height value 808 may be defined as the elevation of the geospatial point above sea level. For different floors on a building, the elevation/height value 808 may be the height of the point with regard to the land where the building is located, or simply an indication of the floor of the building. Elevation/height 808 may be measured in any of a variety of distance measurements, including but not limited to: meters, kilometers, feet, yards, and miles.

The date and time value 810 may be measured in any date/time measurement system, either human readable or computer readable. The date and time value 810 may be used to store a date and time to indicate many different aspects of an electronic file. The date and time value 810 may indicate the date and time an electronic file was created. The date and time value 810 may reference when a specific geospatial point in the geospatial tag architecture 800 was added or modified. The date and time value 810 may also store the date and time for any reason that a user may need to index the point and/or the electronic file linked to the geospatial tag containing the point. Additional elements for the geospatial point data structure 800 are not limited to elevation/height values 808 and date and time values 810. Accordingly, additional elements may include anything that may be used as an index to catalog geospatial points and/or the electronic file linked to the geospatial tag holding the geospatial points.

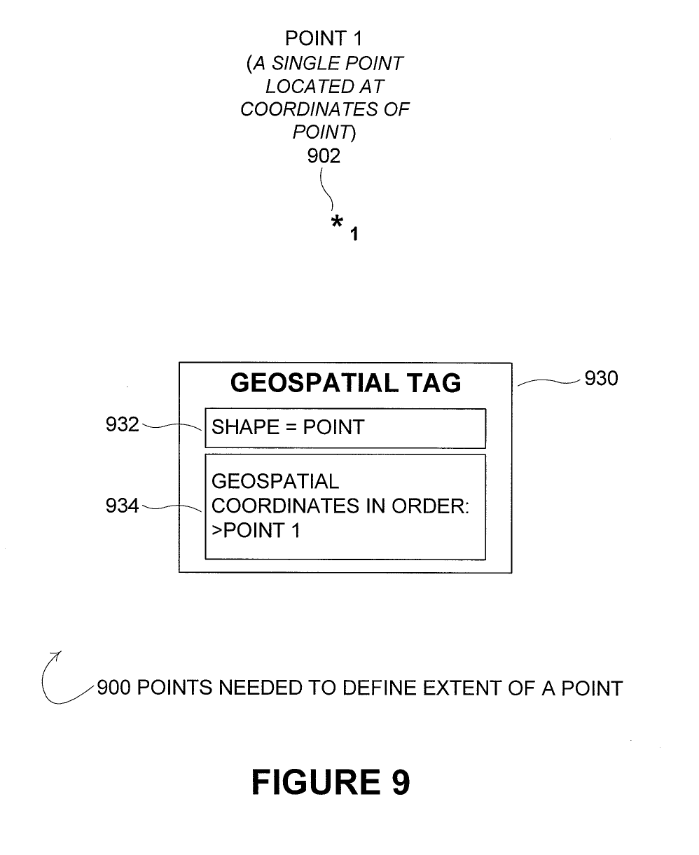

FIG. 9 is a schematic illustration of the points 902 necessary to define the extent of a point shape 900. A point 902 extends to cover an area of only the point 902. The point 902, is the most basic shape that a geospatial tag 930 may define. The point 902 is located at the coordinates defined by point 1 (902). The geospatial tag 930 defines the shape 932 to be a point and lists only point 1 in the ordered list of geospatial points 934. The additional elements of elevation/height and date and time disclosed with respect to FIG. 8 may also be used to define the extents of a point shape 900. By including the additional elements of height or date/time in the geospatial coordinate element 934 of the geospatial tag 930, the point shape is able to convey much more information than just the geographic coordinates of the point shape.

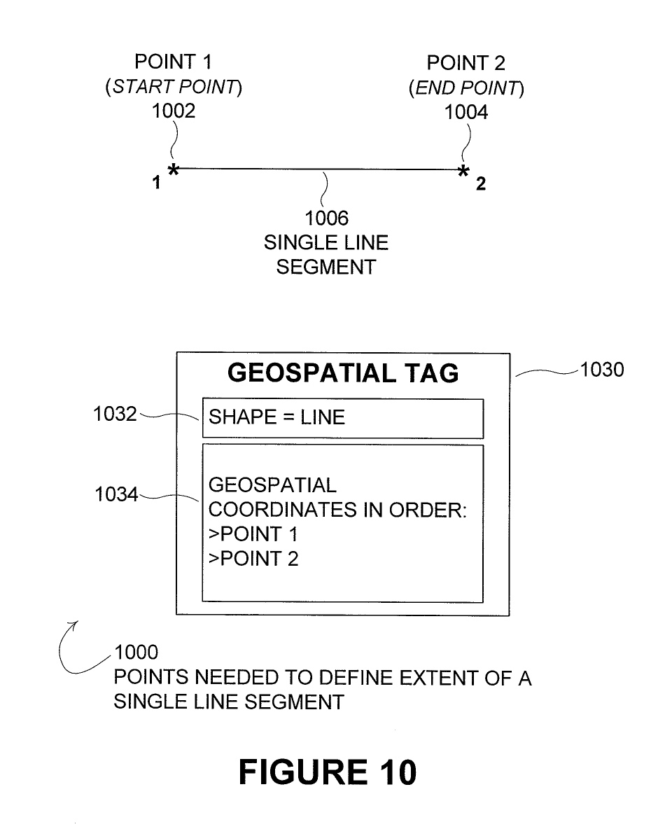

FIG. 10 is a schematic illustration of the points 1002, 1004 necessary to define the extent of a line shape 1000 with a single line segment 1006. A single line segment 1006 extends to cover the two points 1002, 1004 and each point on the straight line segment 1006 between the two points. Two points, point 1 (1002) and point 2 (1004), are necessary to define a single line segment 1006. The geospatial tag 1030 defines the shape 1032 to be a line and lists two points, point 1 (1002) and point 2 (1004), in the ordered list of geospatial points 1034. The single line segment 1006 is a straight line connected between points 1 (1002) and 2 (1004).]

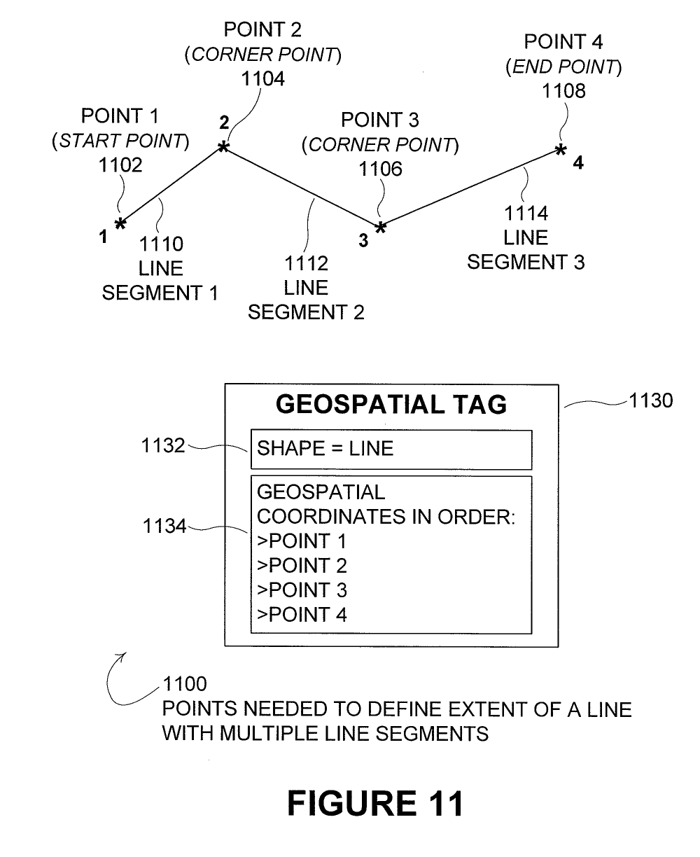

FIG. 11 is a schematic illustration of the points 1102, 1104, 1106, 1108 necessary to define the extent of a line shape 1100 with multiple line segments 1110, 1112, 1114. A line comprising multiple line segments 1110, 1112, 1114 extends to cover an area of each point on each line segment 1110, 1112, 1114. One more point than the number of line segments are necessary to define a line shape 1100 with multiple line segments 1110, 1112, 1114. FIG. 11 shows a line shape 1100 with three line segments 1110, 1112, 1114. Four geospatial points 1102, 1104, 1106, 1108 are necessary to define three line segments 1110, 1112, 1114. Line segment 1 (1110) is the straight line connecting point 1 (1102) to point 2 (1104). Line segment 2 (1112) is the straight line connecting point 2 (1104) to point 3 (1106). Line segment 3 (1114) is the straight line connecting point 3 (1106) to point 4 (1108). The extents of the entire line shape 1100 is the combination of each of the three line segments 1110, 1112, 1114 connected as a single object. The geospatial tag 1130 defines the shape 1132 to be a line and lists four points—point 1 (1102), point 2 (1104), point 3 (1106), and point 4 (1108)—in the ordered list of geospatial points 1134.

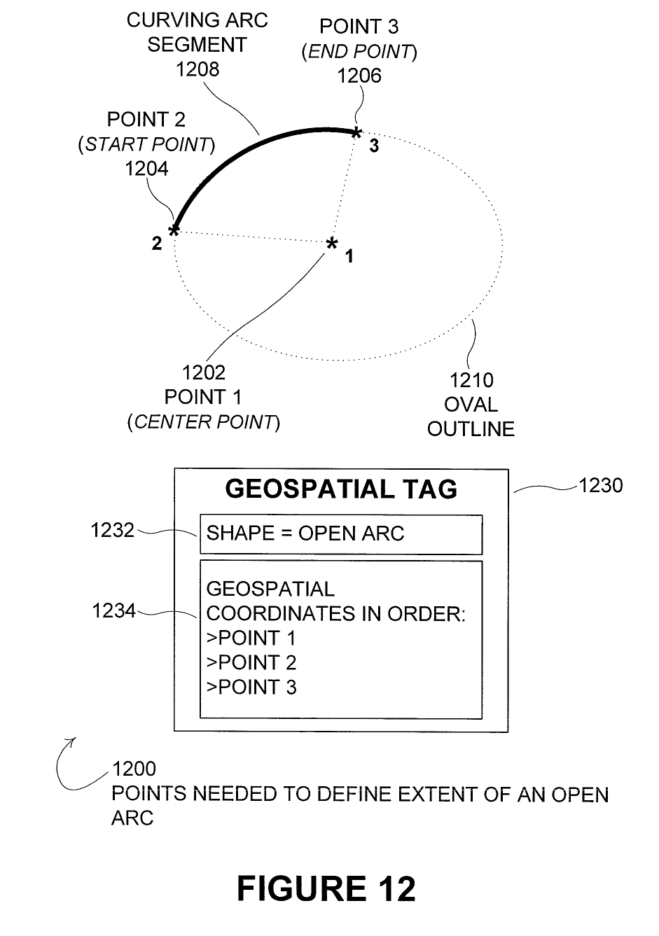

FIG. 12 is a schematic illustration of the points 1202, 1204, 1206 necessary to define the extent of an open arc shape 1200. An open arc extends to cover an area 1208 of the points of a curving arc segment 1208 tracing the perimeter of an oval 1210 between a starting point 1204 and an ending point 1206. Three geospatial points 1202, 1204, 1206 are necessary to define the open arc shape 1200. To define the open arc segment 1208, it is necessary to define a center point 1202 of the oval 1210, a starting point 1204 placed on the oval perimeter 1210, and an ending point 1206 placed on the oval perimeter 1210. With the center point 1202 and two points 1204, 1206 on the oval perimeter 1210, it is possible to calculate the outline of the oval perimeter 1210. After the oval outline 1210 is calculated, it is possible to draw the curving arc segment 1208 between the start point 1204 and the end point 1206. The curving arc segment 1208 may be drawn from the start point 1204 to the end point 1206 either clockwise or counterclockwise. FIG. 12 shows a curving arc segment drawn clockwise from the start point 1204 to the end point 1206. The geospatial tag 1230 defines the shape 1232 to be an open arc and lists three points—point 1 (1202), point 2 (1204), and point 3 (1206)—in the ordered list of geospatial points 1234. For the open arc shape 1200, the order of the points 1202, 1204, 1206 is up to the designer of the system, as long as the order is consistent. However, one point should be a center point 1202 of the oval 1210, a second point 1204 should be a start point 1204 for the curving arc segment 1208, and a third point 1206 should be an end point 1206 for the curving arc segment 1206.

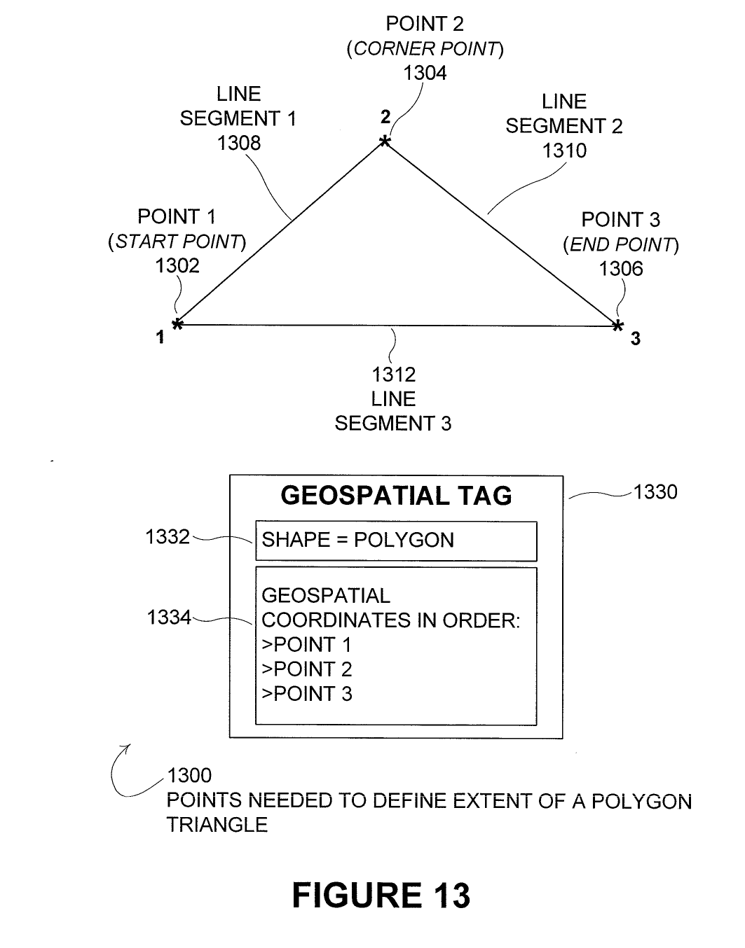

FIG. 13 is a schematic illustration of the points 1302, 1304, 1306 necessary to define the extent of a polygon shape making a triangle 1300. The polygon triangle shape 1300 extends to cover all of the points on each line segment 1308, 1310, 1312 making a triangle, plus all of the points enclosed within the line segments 1308, 1310, 1312 of the triangle. In other words, the extent of the polygon triangle shape 1300 is the area of the triangle with sides of line segment 1 (1308), line segment 2 (1310), and line segment 3 (1312). Three points 1302, 1304, 1306 are necessary to define a polygon triangle shape 1300. Line segment 1 (1308) is the straight line connecting point 1 (1302), the starting point 1302, with point 2 (1304), a corner point 1304. Line segment 2 (1310) is the straight line connecting point 2 (1304), a corner point 1304, with point 3 (1306), the ending point 1306. Unlike a line shape 1000, 1100, the polygon shape 1300 is a closed object. Thus, the end point 1306 is connecting back to the starting point 1302 by line segment 3 (1312). The geospatial tag 1330 defines the shape 1332 to be a polygon and lists three points—point 1 (1302), point 2 (1304), and point 3 (1306)—in the ordered list of geospatial points 1334. The polygon shown in FIG. 13 is a triangle with three sides 1308, 1310, 1312, but other polygon shapes may define a polygon with any number of sides, including but not limited to: squares, rectangles, pentagons, hexagons, etc.

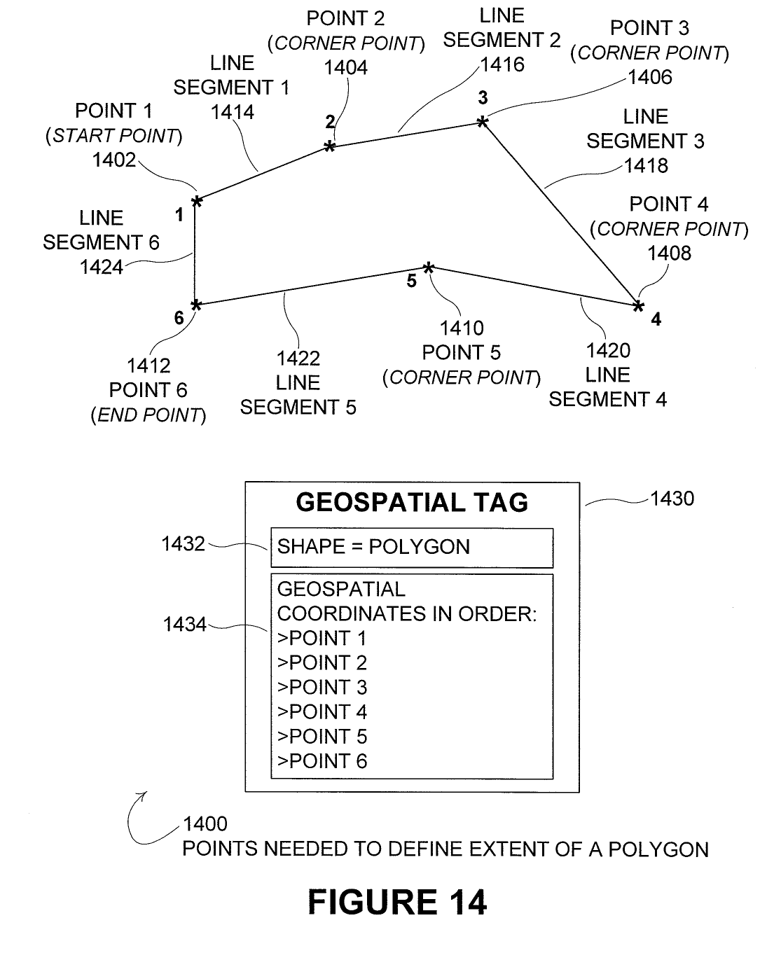

FIG. 14 is a schematic illustration of the points 1402, 1404, 1406, 1408, 1410, 1412 necessary to define the extent of a polygon shape 1400. The polygon shape 1400 extends to cover all of the points on each line segment 1414, 1416, 1418, 1420, 1422, 1424 enclosing the polygon, plus all of the points enclosed within the line segments 1414, 1416, 1418, 1420, 1422, 1424 of the polygon. In other words, the extent of the polygon shape 1400 is the area of the polygon with sides of line segment 1 (1414), line segment 2 (1416), line segment 3 (1418), line segment 4 (1420), line segment 5 (1422), and line segment 6 (1424). The number of points necessary to define a polygon is equal to the number of sides of the polygon. The polygon shape 1400 of FIG. 14 has six points 1402, 1404, 1406, 1408, 1410, 1412 and six sides 1414, 1416, 1418, 1420, 1422, 1424. Line segment 1 (1414) is the straight line connecting point 1 (1402), the starting point 1402, with point 2 (1404), a corner point 1404. Line segment 2 (1416), is the straight line (1416) connecting point 2 (1404), a corner point 1404, with point 3 (1406), another corner point 1406. Line segment 3 (1418), is the straight line (1418) connecting point 3 (1406), a corner point 1406, with point 4 (1408), another corner point 1408. Line segment 4 (1420), is the straight line (1420) connecting point 4 (1408), a corner point 1408, with point 5 (1410), another corner point 1410. Line segment 5 (1422), is the straight line (1422) connecting point 5 (1410), a corner point 1410, with point 6 (1412), the ending point 1412. Line segment 6 (1424), is the straight line 1424 connecting point 6 (1412), the ending point 1412, with point 1 (1402), the starting point 1402, enclosing the polygon 1400. The geospatial tag 1430 defines the shape 1432 to be a polygon and lists six points—point 1 (1402), point 2 (1404), point 3 (1406), point 4 (1408), point 5 (1410), and point 6 (1412)—in the ordered list of geospatial points 1434. The polygon shown in FIG. 14 is a six sided object 1400. A polygon shape is not limited to six sides and may be defined with any number of sides, including but not limited to: squares, rectangles, pentagons, hexagons, etc.

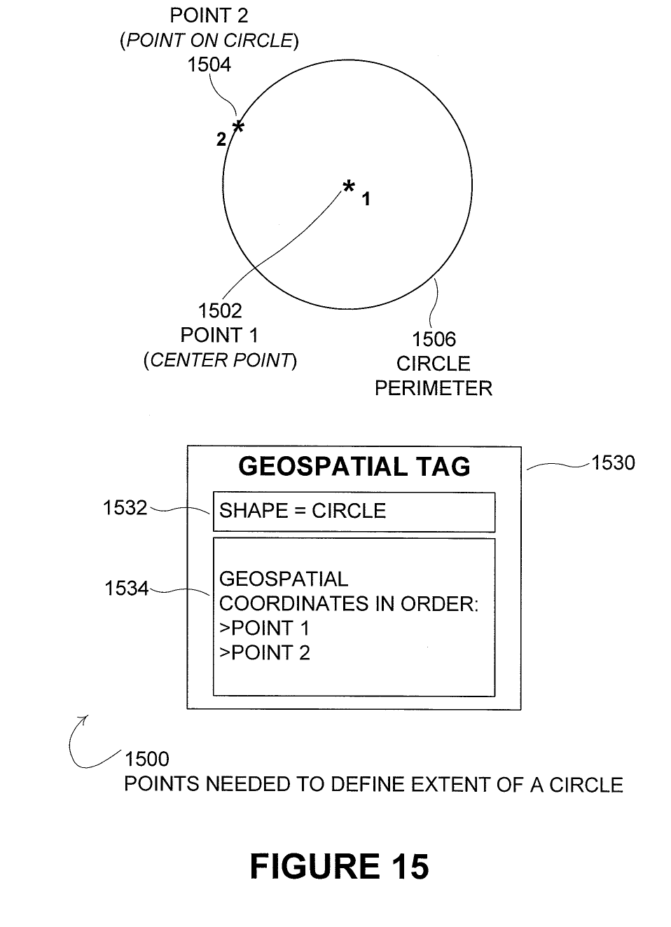

FIG. 15 is a schematic illustration of the points 1502, 1504 necessary to define the extent of a circle shape 1500. The circle shape 1500 extends to cover all of the points on the circle perimeter 1506, plus all of the points enclosed within the circle perimeter 1506. In other words, the extent of the circle shape 1500 is the area of the circle 1506. Two geospatial points 1502, 1504 are necessary to define the circle shape 1500. To define the circle perimeter 1506, it is necessary to define a center point 1502 of the circle 1506 and any point 1504 on the circle perimeter 1506. With the center point 1502 and one point 1504 on the circle perimeter 1506, it is possible to calculate the outline of the circle perimeter 1506. The geospatial tag 1530 defines the shape 1532 to be a circle and lists two points—point 1 (1502) and point 2 (1504)—in the ordered list of geospatial points 1534. For the circle shape 1500, the order of the points 1502, 1504 is up to the designer of the system, as long as the order is consistent. However, one point should be a center point 1502 of the circle 1506 and a second point should be any point 1504 on the perimeter of the circle 1506.

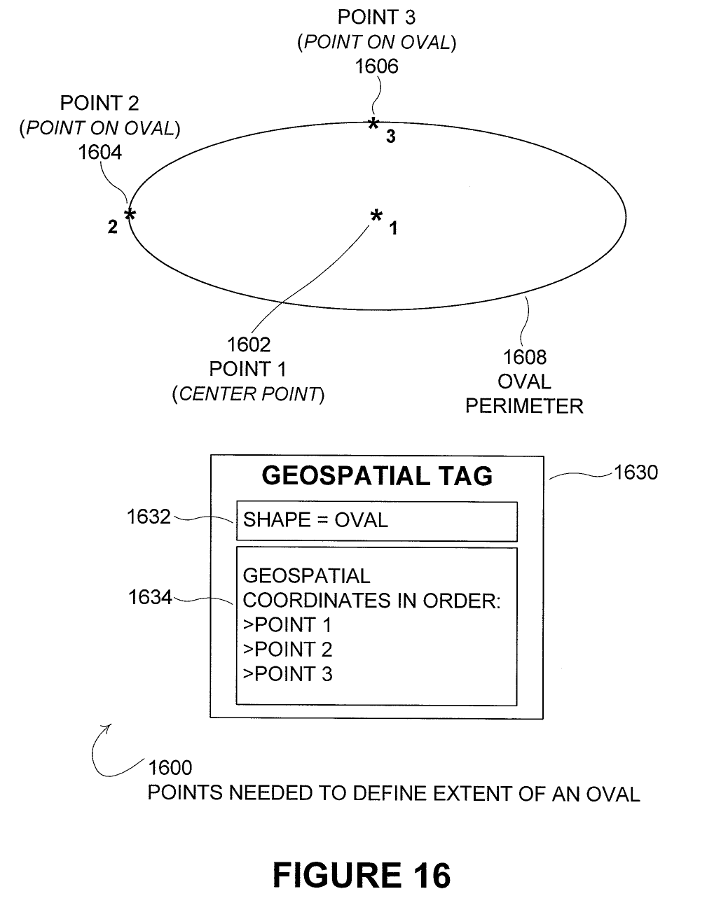

FIG. 16 is a schematic illustration of the points 1602, 1604, 1606 necessary to define the extent of an oval shape 1600. The oval shape 1600 extends to cover all of the points on the oval perimeter 1608, plus all of the points enclosed within the oval perimeter 1608. In other words, the extent of the oval shape 1600 is the area of the oval 1608. Three geospatial points 1602, 1604, 1606 are necessary to define the oval shape 1600. To define the oval perimeter 1506, it is necessary to define a center point 1602 of the oval 1608 and two points 1604, 1606 on the oval perimeter 1608. With the center point 1602 and two points 1604, 1606 on the oval perimeter 1608, it is possible to calculate the outline of the oval perimeter 1608. The geospatial tag 1630 defines the shape 1632 to be an oval and lists three points—point 1 (1602), point 2 (1604), and point 3 (1606)—in the ordered list of geospatial points 1634. For the oval shape 1600, the order of the points 1602, 1604, 1606 is up to the designer of the system, as long as the order is consistent. However, one point should be a center point 1602 of the oval 1608, a second point should be any point 1604 on the perimeter of the oval 1608, and a third point 1606 should be any point other than point 2 (1604) on the perimeter of the oval 1608. To ensure that the oval 1608 appears as desired, it is better to separate the two points 1604, 1606 on the oval 1608 such that one point 1604 is near the wide portion of the oval and the other point 1606 is near the narrow portion of the oval.

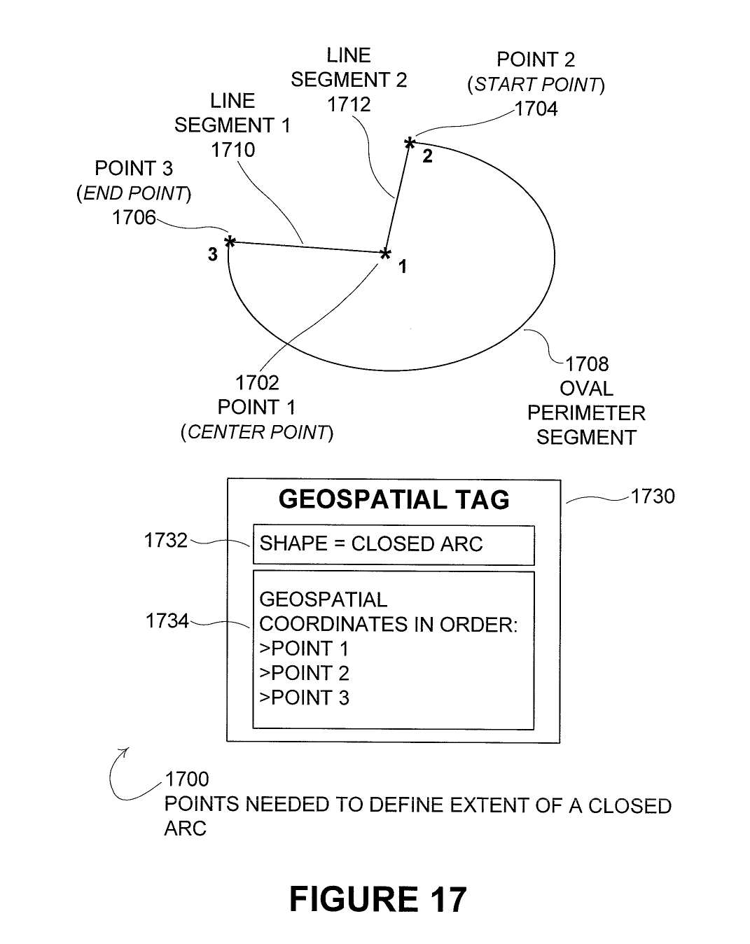

FIG. 17 is a schematic illustration of the points 1702, 1704, 1706 necessary to define the extent of a closed arc shape 1700. A closed arc traces the perimeter of an oval for a partial oval perimeter segment 1708 traced between a starting point 1704 and an ending point 1706, plus the closed arc shape 1700 has straight line segments 1710, 1712 connecting the starting point 1704 and the ending point 1706 to the center point 1702 such that the closed arc shape 1700 looks like a pie with a piece cut out. The closed arc shape 1700 extends to cover all points in the area of the oval, but excluding the points in the cut out “pie” piece. The points on the oval perimeter segment 1708 and the two straight line segments 1710, 1712 are also included in the extent of the closed arc shape 1700. Three geospatial points 1702, 1704, 1706 are necessary to define the closed arc shape 1700. To define the closed arc shape 1700, it is necessary to define a center point 1702 of the oval, a starting point 1704 placed on the oval perimeter, and an ending point 1706 placed on the oval perimeter. With the center point 1702 and two points 1704, 1706 on the oval perimeter, it is possible to calculate the outline of the oval perimeter. After the oval outline is calculated, it is possible to draw the oval perimeter segment 1708 between the start point 1704 and the end point 1706. The oval perimeter segment 1708 may be drawn from the start point 1704 to the end point 1706 either clockwise or counterclockwise. FIG. 17 shows a oval perimeter segment 1708 drawn clockwise from the start point 1704 to the end point 1706. To close the arc, a line 1712 is drawn from the start point 1704 to the oval center 1702 and another line 1710 is drawn from the end point 1706 to the oval center 1702. The two lines 1710, 1712 meet at the oval center 1702 and close the arc to create a closed arc shape 1700. The geospatial tag 1730 defines the shape 1732 to be a closed arc and lists three points—point 1 (1702), point 2 (1704), and point 3 (1706)—in the ordered list of geospatial points 1734. For the closed arc shape 1700, the order of the points 1702, 1704, 1706 is up to the designer of the system, as long as the order is consistent. However, one point should be a center point 1702 of the oval, a second point 1704 should be a start point 1704 for the oval perimeter segment 1708, and a third point 1706 should be an end point 1706 for the oval perimeter segment 1708.

While an embodiment may specify a shape type and a list of ordered geospatial tags to define the extents of a shape, other embodiments may define the shape using other mathematical methods. By including an elevation/height value in the geospatial point, it is also possible to represent volumes and three dimensional objects using a geospatial tag.

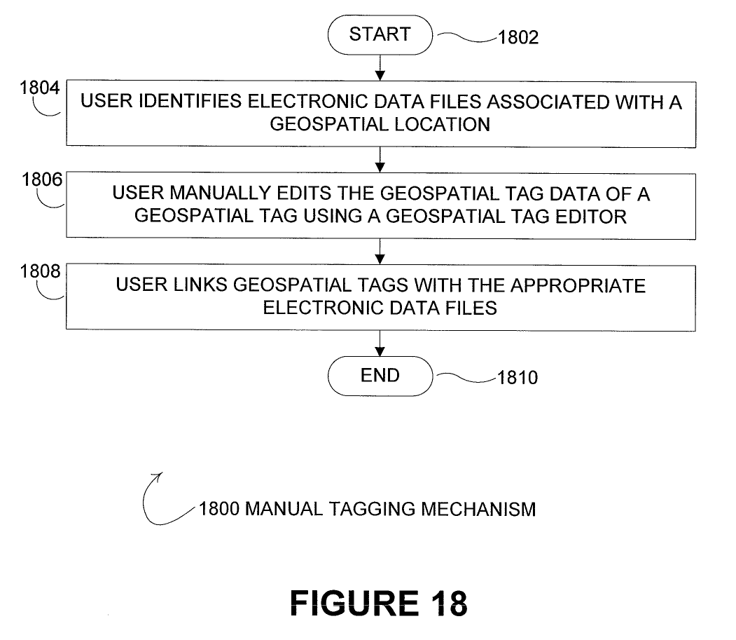

FIG. 18 is a flow chart 1800 describing the steps of a manual geospatial file tagging mechanism. To start 1802, the user identifies electronic data files associated with a geospatial location 1804. The user then manually edits the geospatial tag data of a geospatial tag using a geospatial tag editor software tool 1806. The geospatial tag editing software tool may be as simple as a text editor or much more sophisticated. The tag editing tool may be an extension of the sophisticated land software tool disclosed in the cross-referenced U.S. patent application Ser. No. 11/339,267, entitled “Land Software Tool,” filed on Jan. 24, 2006 by Craig D. Harrison and James J. Graham. The disclosed land software tool includes a variety of methods for manually entering and/or drawing boundaries that may be used to establish the geospatial location information that is stored in the geospatial tag. Some of the tools provided by the disclosed land software tool include: a drawing tool, a metes and bounds tool, a table of latitude and longitudes tool, and a Global Positioning System (GPS) field entry tool for entering geospatial coordinate points in the field using a GPS device.

The manually entered geospatial location information may include: a shape drawn on a digital map using a drawing tool; a shape drawn on a digital image using a drawing tool, a street address; latitude and longitude coordinates; Universal Transverse Mercator (UTM) coordinates; county; postal code; parcel; tract, lot and block; and township, range, and section. The conversion to geospatial coordinates may include converting the manually entered geospatial location into latitude/longitude coordinates, UTM coordinates, or any other appropriate geospatial coordinate system. Typically, the manually entered geospatial location may be converted into an appropriate geospatial coordinate system using a database of possible locations with the relation to the geospatial coordinate system and/or a software program that performs the necessary functions to change the geospatial location data into the appropriate geographic coordinate system. Postal codes, tract lot and block, township range and section, and street addresses are typical geospatial location data that may require a database to store the appropriate geospatial location data to correlate with the proper geographical coordinate system. The geographic coordinates may be stored in the geospatial tag coordinate format.

After the geospatial location information is stored in the geospatial tag 1806, the user then links the geospatial tags with the appropriate electronic data files 1808. The disclosed land software tool may be enhanced such that the land software tool allows the user to create a boundary/shape, create a geospatial tag to hold the boundary/shape information, and then provide an interface to permit the user to link geospatial tags with the associated electronic files. Once the geospatial tag is linked to the electronic files 1808, the tagging process is ended 1810.

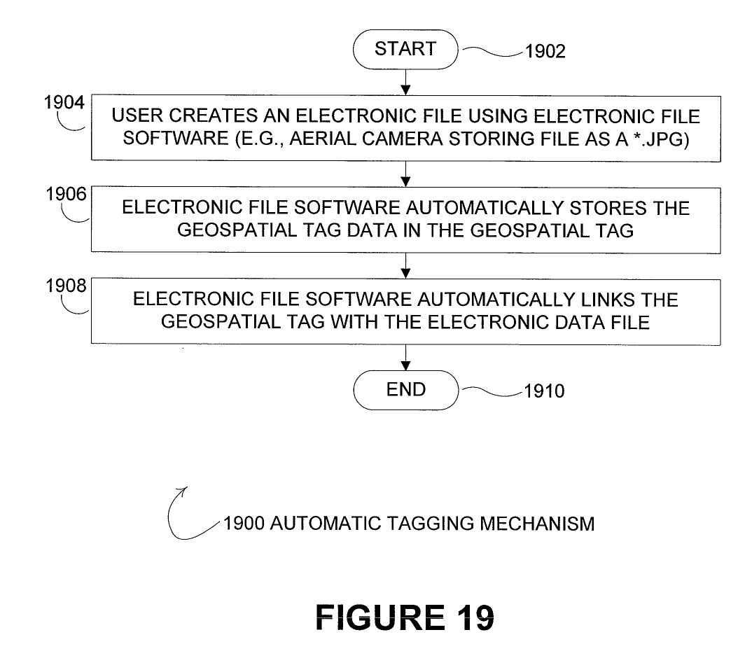

FIG. 19 is a flow chart 1900 describing the steps of an automatic geospatial file tagging mechanism. To start 1902, the user creates an electronic file using electronic file creation software 1904. The electronic file creation software then stores the geospatial location data of the electronic file in a geospatial tag 1906. The electronic file software finally links the geospatial tag with the electronic data file 1908 to bring the process to an end 1910. A digital aerial camera with a tagging mechanism to mark the area photographed on the electronic file produced by the camera is a good example of how electronic file software may be used to automatically tag files with a geospatial tag. As with the process for manually tagging files disclosed with respect to FIG. 18, the disclosed land software tool of Harrison et al. may be used to enhance the electronic file software to make the description of the geospatial location information easier to input into the system.

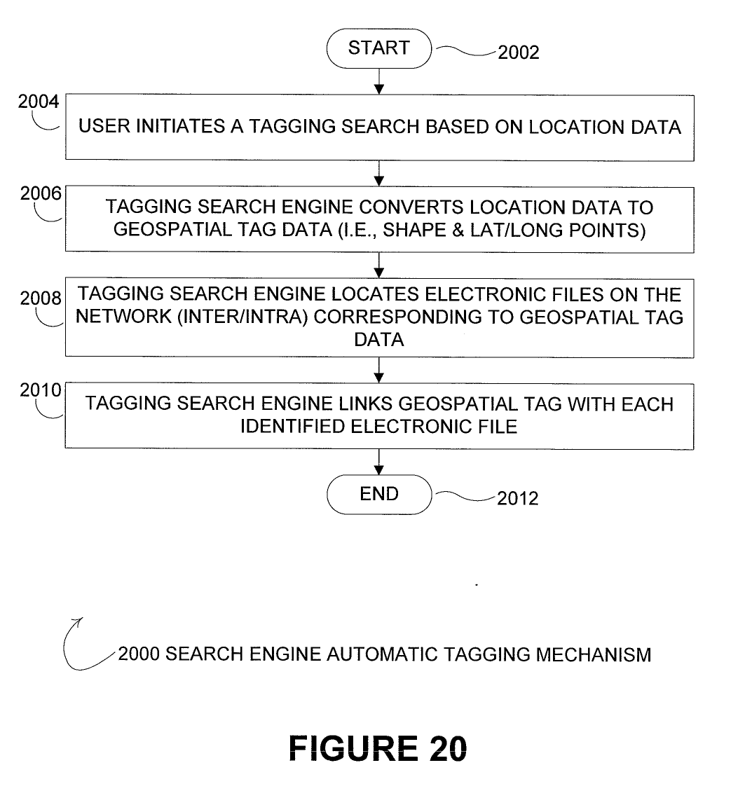

FIG. 20 is a flow chart 2000 describing the steps of a search engine based automatic geospatial file tagging mechanism. To start 2002, the user initiates a tagging search based on location data 1904. The location data may be entered in numerous ways and using numerous formats. For instance, the location data may be entered as text or the data may be entered using the land software tool of Harrison et al. such that the location is entered as a border drawn on a map or image using the various methods of creating borders available in the Harrison et al. land software tool. The location may be latitude/longitude coordinates, Universal Transverse Mercator (UTM) coordinates, postal address, postal code, township range and section, tract lot and block, or any other format used to define a geospatial location. As with the process for manually tagging files disclosed with respect to FIG. 18, the disclosed land software tool of Harrison et al. may be used to enhance the user entry of location data to make the description of the geospatial location information easier to input into the system. Once the tagging search engine is activated 2004, the tagging search engine converts the location data to the appropriate format to place in a geospatial tag 2006. One embodiment may convert the location data into geospatial tag data by defining a shape element and a geographic coordinate element as disclosed with respect to FIGS. 7-17. Using the location data converted to geospatial tag data 2006, the tagging search engine then locates electronic files on a computer network containing geospatial data corresponding to the geospatial tag 2008. The computer network may be a private intranet and/or the public Internet. The tagging search engine may convert location data found in electronic files to the same format as the geospatial tag data in order to determine whether the electronic file should be linked with the geospatial tag. After locating the electronic files associated with the geospatial tag 2008, the tagging search engine links the geospatial tag with each of the identified electronic files 2010.

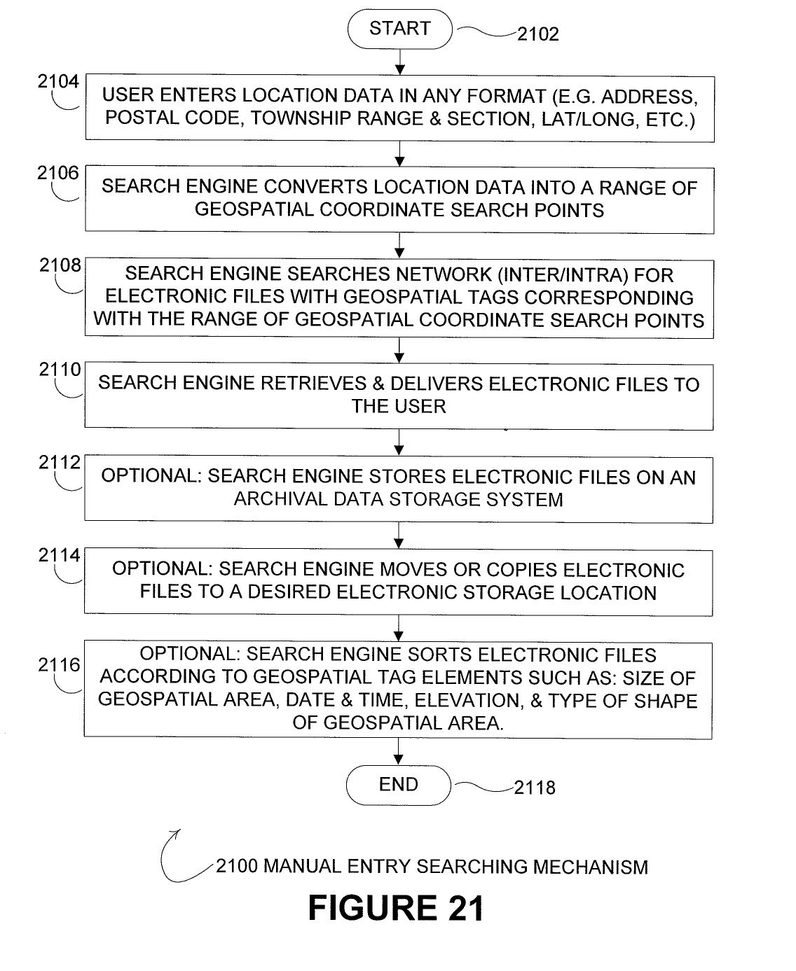

FIG. 21 is a flow chart 2100 describing the steps of a geospatial tag based searching mechanism using a manually entered geospatial location as the basis for the search. To start 2102, a user enters location data in any format 2104. The location data may be entered in numerous ways using numerous formats. For instance, the location data may be entered as text. The location may be latitude/longitude coordinates, Universal Transverse Mercator (UTM) coordinates, postal address, postal code, township range and section, tract lot and block, or any other format used to define a geospatial location. After obtaining location data from the user 2104, the search engine converts the location data into a range geospatial search points 2106. The range of geospatial coordinates may encompass shapes as is done with the geospatial tag. As disclosed with respect to FIG. 8, a geospatial search point consists of the X and Y coordinates of a geographic coordinate system and may further consist of additional elements such as elevation/height and/or date and time. Depending on the shape or type of location data, the range of geospatial search points may consist of a single geospatial point or a plurality of geospatial points encompassing a shape. Once the location data is converted into the range of geospatial search points 2106, the search engine searches a computer network for all electronic files linked to geospatial tags corresponding to the range of geospatial search points 2108. A geospatial tag corresponds to the range of geospatial search points by delineating an area which equals or overlaps (either partially or completely) the range of search points found in step 2106. The computer network searched may be a private intranet and/or the public Internet. After locating electronic files associated with the search location data 2108, the search engine then retrieves and delivers the identified electronic files 2110. The search engine may then perform a number of additional and optional functions. The search engine may store the electronic files on an archival data storage system in order to archive the files for safekeeping 2112. The search engine may also move or copy the identified electronic files to a desired electronic storage location so that the user may edit and manipulate the files without affecting the original files 2114. Further, the search engine may sort the identified electronic files according to geospatial tag elements 2116. The sorting logic may take many forms including: sorting by size of geospatial area, sorting by date and time of geospatial points, sorting by elevation/height of geospatial points, sorting by shape of geospatial area, sorting by a combination of elements, or any other sorting logic that may be derived from the geospatial tags. The search is ended 2118 once the user has completed the search and performed any optional steps desired.

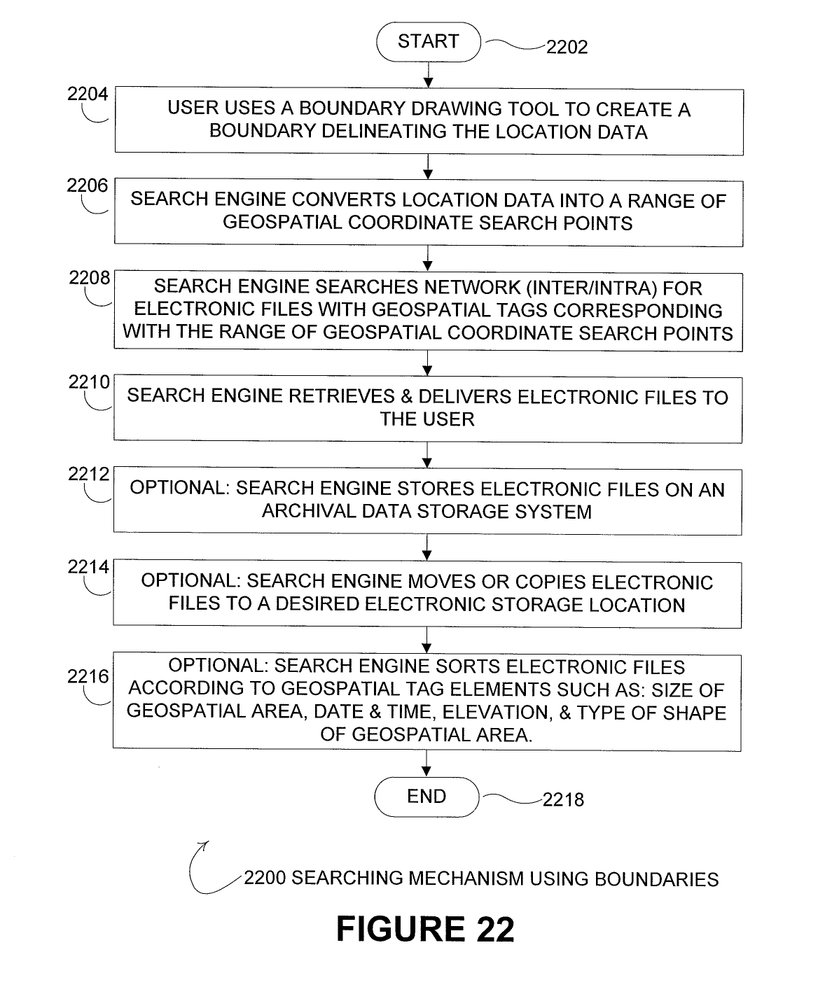

FIG. 22 is a flow chart 2200 describing the steps of a geospatial tag based searching mechanism using a geospatial location defined by a border drawing tool as the basis for the search. To start 2202, a user uses boundary/shape drawing tools to create a boundary delineating the location data 2204. An example of a boundary/shape drawing tool would include the land software tool of Harrison et al., which permits a user to create a boundary/shape using a variety of methods such as entering a metes and bounds description or using a drawing tool to trace the boundary/shape on digital maps and images. As with the process for manually tagging files disclosed with respect to FIG. 18, the disclosed land software tool of Harrison et al. may be used to enhance the user entry of location data to make the description of the geospatial location information easier to input into the system. After obtaining the boundary/shape location data from the user 2204, the search engine converts the location data into a range geospatial search points 2206. The range of geospatial coordinates may encompass shapes as is done with the geospatial tag. As disclosed with respect to FIG. 8, a geospatial search point consists of the X and Y coordinates of a geographic coordinate system and may further consist of additional elements such as elevation/height and/or data and time. Depending on the shape or type of location data, the range of geospatial search points may consist of a single geospatial point or a plurality of geospatial points encompassing a shape. Once the location data is converted into the range of geospatial search points 2206, the search engine searches a computer network for all electronic files linked to geospatial tags corresponding to the range of geospatial search points 2208. A geospatial tag corresponds to the range of geospatial search points by delineating an area which equals or overlaps (either partially or completely) the range of search points found in step 2206. The computer network searched may be a private intranet and/or the public Internet. After locating electronic files associated with the search location data 2208, the search engine then retrieves and delivers the identified electronic files 2210. The search engine may then perform a number of additional and optional functions. The search engine may store the electronic files on an archival data storage system in order to archive the files for safekeeping 2212. The search engine may also move or copy the identified electronic files to a desired electronic storage location so that the user may edit and manipulate the files without affecting the original files 2214. Further, the search engine may sort the identified electronic files according to geospatial tag elements 2216. The sorting logic may take many forms including: sorting by size of geospatial area, sorting by date and time of geospatial points, sorting by elevation/height of geospatial points, sorting by shape of geospatial area, sorting by a combination of elements, or any other sorting logic that may be derived from the geospatial tags. The search is ended 2218 once the user has completed the search and performed any optional steps desired.

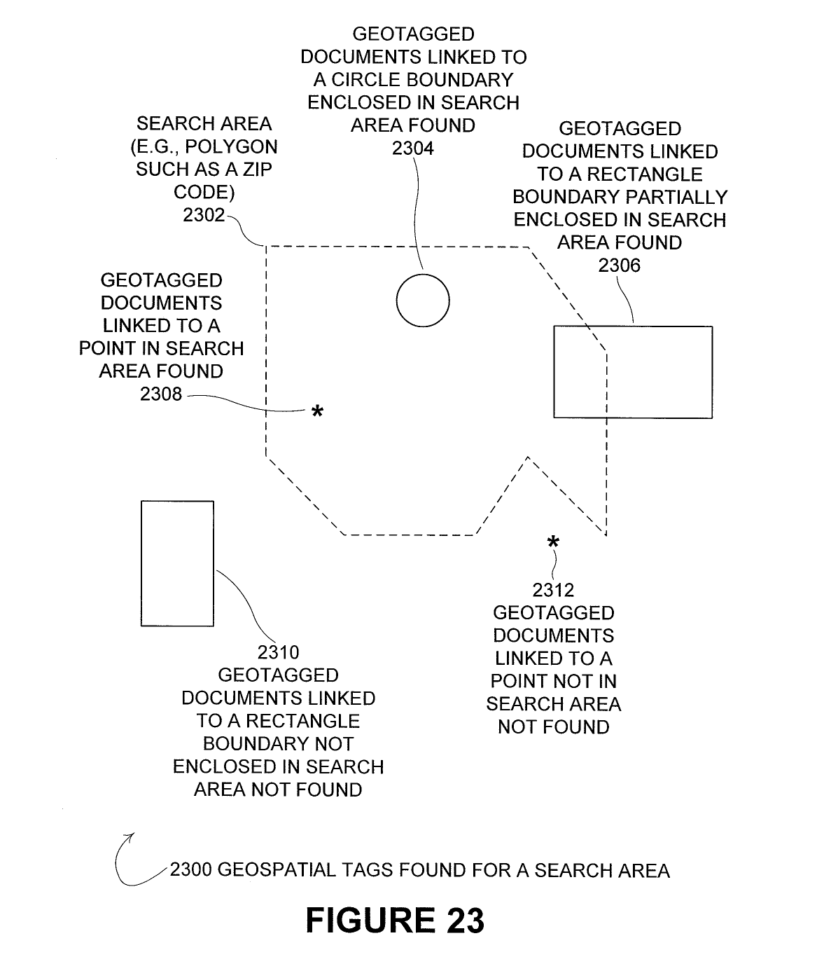

FIG. 23 is a schematic illustration 2300 of a variety of geospatial tags 2304, 2306, 2308 found for a specific search area 2302. A search area 2302 may be comprised of any shape definable by a geospatial tag. The search area 2302 shown in FIG. 23 is a polygon. A polygon may be used to represent many types of locations including, but not limited to: a postal code, a plot of land, city boundaries, county boundaries, state boundaries, and country boundaries. When searching for geospatial tags corresponding to the search area 2302, any electronic file with a geospatial tag describing an area that completely or partially overlaps the search area will be found. For instance, the search engine will retrieve documents linked with the point geospatial tag 2308 and the circle geospatial tag 2304 that are completely enclosed within the search area 2302. Similarly, the search engine will retrieve documents linked with the rectangle geospatial tag 2306 that only partially overlaps the search area 2302. The search engine will not retrieve documents linked with either the rectangle geospatial tag 2310 or the point geospatial tag 2312 that do not overlap the search area 2302.

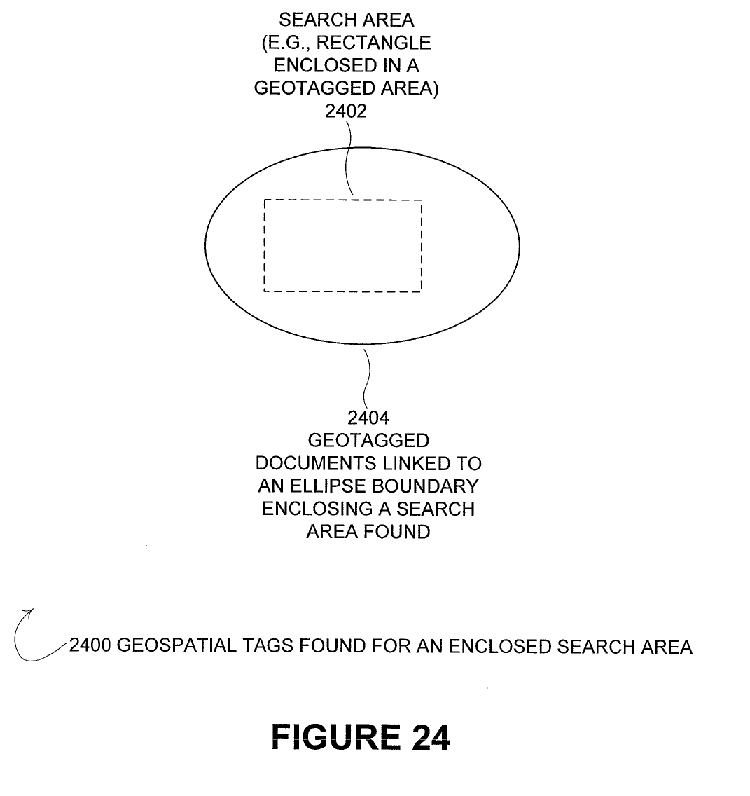

FIG. 24 is a schematic illustration 2400 of geospatial tags found for a search area 2402 enclosed within the area described by the rectangle geospatial tag 2404. The search engine will retrieve electronic documents linked to a geospatial tag which overlaps the search area 2402 in any fashion. Overlap of the search area 2402 includes the case, as shown in FIG. 24, where the search area 2402 is completely enclosed within an area delineated by a geospatial tag 2404. For FIG. 24, the rectangle search area 2402 is completely enclosed within the oval geospatial tag area 2404. Thus, the documents linked to the oval geospatial tag 2404 are retrieved for a search based on the rectangle search area 2402.

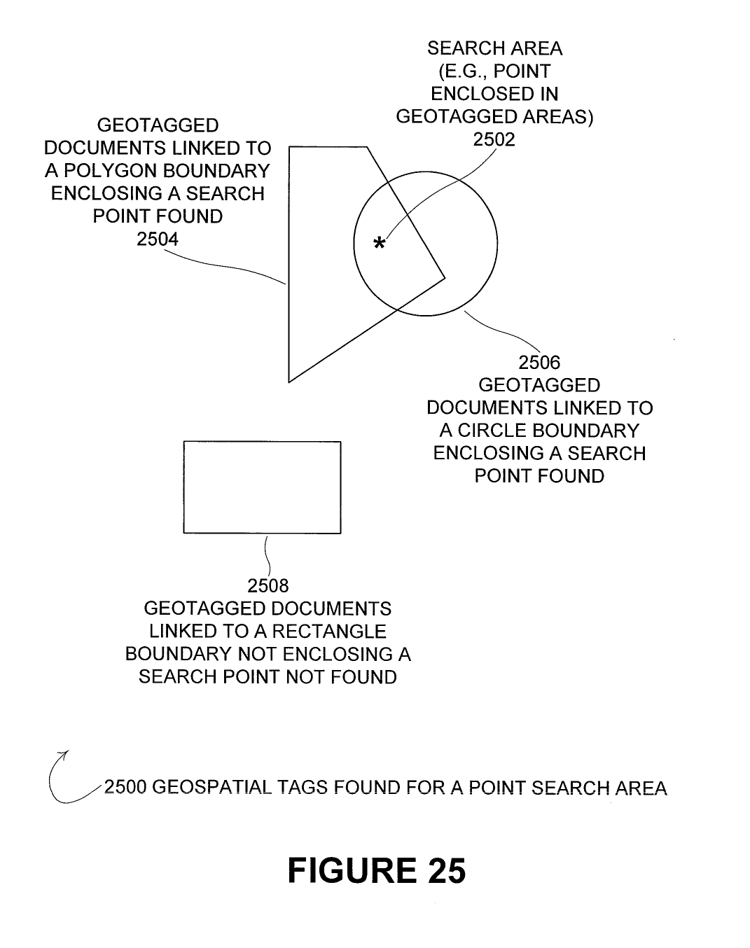

FIG. 25 is a schematic illustration 2500 of the geospatial tags found 2504, 2506 for a point search area 2502. A search area may also be a point 2502. The search engine will retrieve documents linked with geospatial tags 2504, 2506 which overlap the search point 2502. For FIG. 25, the search area is a point 2502. The polygon geospatial tag 2504 and the circle geospatial tag 2506 both overlap the search point 2502. Thus, electronic files linked with the polygon 2504 and circle 2506 geospatial tags will be retrieved by the search engine. The rectangle geospatial tag 2508 does not overlap the point search area 2502, so documents linked with the rectangle geospatial tag 2508 will not be retrieved by the search engine. If a document is linked to multiple geospatial tags, the document will be retrieved if any of the linked geospatial tags overlap the search area.

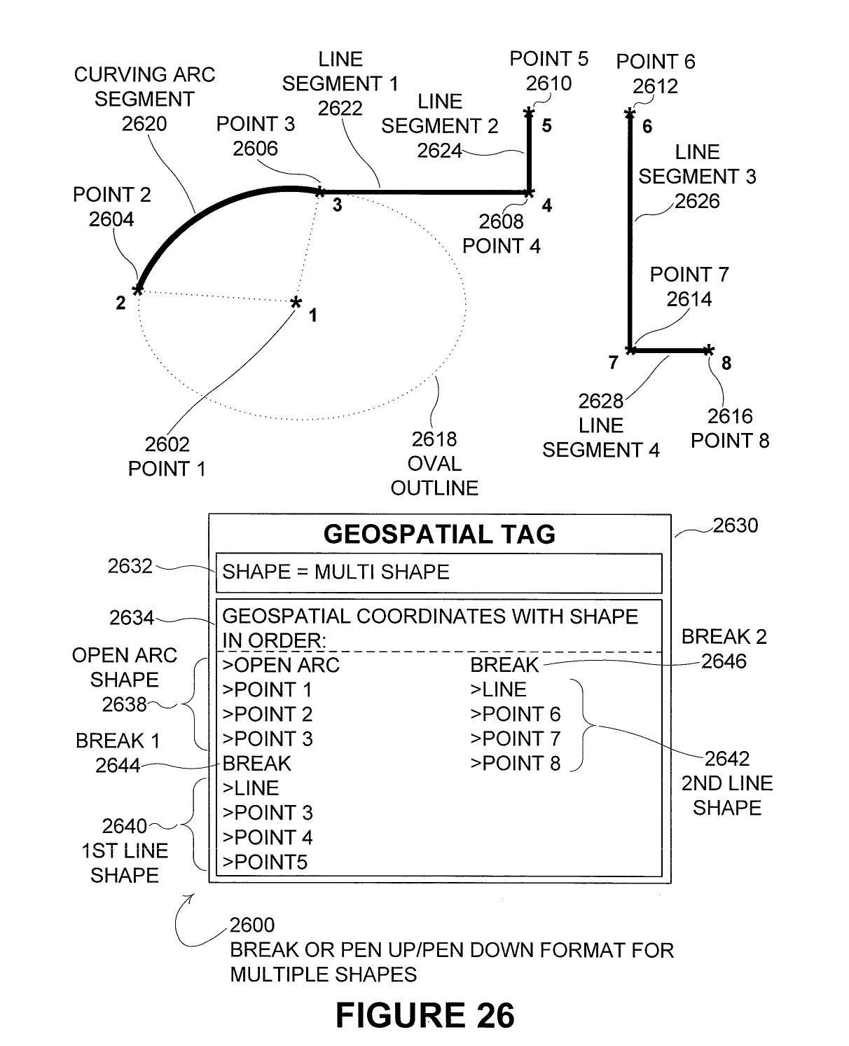

FIG. 26 is a schematic illustration of a geospatial tag 2630 implementing multiple shapes 2600 using breaks for pen up/pen down functionality. An embodiment may include multiple shapes 2600 in a single geospatial tag 2630. For instance, in FIG. 26 the geospatial tag 2630 delineates an open arc 2620 connected to a line 2622, 2624 and another line 2626, 2628 not connected to either the first line 2622, 2624 or the open arc 2620. The geospatial tag 2630 has a shape element 2632 that indicates it is a Multi Shape (i.e., consists of multiple shapes). The geospatial coordinate element 2634 includes the shape and points 2638, 2640, 2642 to define each of the multiple shapes 2600. The geospatial coordinate element 2634 also includes break markers 2644, 2648. These break markers indicate a pen up and pen down situation. The break markers may also indicate that a new shape should be drawn. For instance break point 1 (2644) would pen up at point 3 (2606), change the shape to a line (2640), and pen down at point 3 (2606) again. Because the pen up and pen down occur at the same point, point 3 (2606), the open arc shape 2638 is connected to the first line shape 2640. It is not necessary that each shape connect to the next shape. For instance, the first line shape 2640 does not connect with the second line shape 2642. At break point 2 (2646), the pen up occurs at point 5 (2610) and the pen down occurs at point 6 (2612). Due to the pen up/pen down action, there is not a line drawn between point 5 (2610) and point 6 (2612).

Each of the individual shapes 2638, 2640, 2642 of the geospatial coordinate element 2634 of the multi shape geospatial tag 2630 are drawn as described for each individual shape with respect to FIGS. 9-17, respectively. For FIG. 26, there is an open arc shape 2638, a first line shape 2640, and a second line shape 2642. The open arc shape 2638 is drawn according to the description with respect to FIG. 12. Point 1 (2602) is the center point 2602 of the oval outline 2618. Point 2 (2604) is the starting point 2604 of the curving arc segment 2620, and point 3 (2606) is the ending point 2606 of the curving arc segment 2620. The first 2640 and second 2642 line shapes are drawn according to the description with respect to FIG. 11. For the first line shape 2640, point 3 (2606) is the starting point 2606. Point 3 (2606) connects to a corner point 2608, point 4 (2608) with line segment 1 (2622). The corner point 2608 connects to point 5 (2610), which is also the end point 2610. Point 4 (2608) is connected to point 5 (2610) with line segment 2 (2624). For the second line shape 2642, point 6 (2612) is the starting point 2612. Point 6 (2612) connects to a corner point 2614, point 7 (2614) via line segment 3 (2626). The corner point 2614 connects to point 8 (2616), which is also the end point 2616. Point 7 (2614) is connected to point 8 (2616) via line segment 4 (2628).

As can be seen in FIG. 26, a single geospatial tag 2630 may be used to describe multiple shapes. If multiple shapes, such as line shapes and open arc shapes, enclose an area, the enclosed area may be used to define the extents of the geospatial tag. Thus, a shape similar to a polygon may include an open arc shape as one of the sides of the polygon-like object. By defining multiple shapes in a single tag, an embodiment may permit linking electronic documents (e-documents) with very complex geospatial shapes.

An embodiment may implement the geospatial tag structure in a variety of ways. An embodiment may structure the geospatial tag elements in the format for eXtensible Markup Language (XML). For an embodiment using the XML format, an XML element may be used to indicate a break point 2644, 2646 for a multi shape geospatial tag 2630. Thus, the widely known, standard XML format may be used to implement even the complex multi shape geospatial tag 2630 of FIG. 26.

Various embodiments may therefore provide a software tool to tag, search, archive, and retrieve electronic documents based on geospatial data associated with the electronic documents. With the advancement of information technology, most documents are now created in digital form and older documents are being scanned and digitized for electronic storage everyday. Various embodiments are capable of identifying the electronic documents associated with a specific geospatial location and retrieving the identified documents so that all documents related to the specific geospatial location are stored together in one location. With the documents gathered into one location, an embodiment may copy, move, or archive the electronic files as desired by the user for editing, manipulation, backup, and safekeeping of the electronic files. The electronic files may also be sorted based on the elements of the geospatial tag. For instance, documents may be sorted by geospatial size, shape, elevation, date and time, etc. of the geospatial tag the document is linked with. Thus, the various embodiments permit a user to organize, search, and sort electronic files based on geospatial location data associated with each electronic file.

The task of collecting the large variety of documents relating to a specific piece of real estate is, in many cases, a time consuming and difficult task. Collecting the documents is a process that usually involves a multitude of professionals gathering data and generating reports, studies and opinions regarding the varied subject matter. The typical due diligence period on a purchase of real estate varies depending on the type of real estate being sold or investigated and could take up to one year to complete. In the due diligence process, the most time consuming aspect is the gathering of pertinent information.

Typically, a person searches through a collection of paper documents looking for some indication that a paper document is related to the real estate in question. With the advent of computers, many of the paper documents are being digitized and stored on computer systems. However, even digitized documents do not typically have a readily accessible geospatial reference to indicate a geospatial location to associate with the document. Often, the geospatial location information is contained in the body of the document, which means a search of the entire body of the document is necessary to obtain the geospatial location associated with the document. Many digitized documents are simply scanned versions of the paper documents, meaning a person must read through each document in order to retrieve the geospatial location associated with each document.

In the past, the typical real estate transaction might have only utilized a title abstract update and a deed. Today, real estate transactions now utilize 20-100, or more, documents at closing, depending on the complexity of the deal. As time goes on, the number of documents needed to close a transaction will expand even further. As new real estate transactions occur, more real estate documents are being generated daily.

Real estate and land is considerable in size and acreage and a multitude of documents may be generated associated with various geographic locations. To make matters more difficult, the geospatial location information in the various documents is frequently given in different measurement/coordinate systems on different documents. Thus, a person may not recognize that two documents using two different coordinate systems are actually associated with the same piece of real estate. Further, most geospatial locations consist of a shape, such as the area of a postal code or the extent of a property boundary. Two different coordinate systems may define shapes that partially overlap. For instance, a postal code may have only a portion of a property boundary overlapping the postal code. Typically, the property boundary and postal code are boiled down to a single geographic coordinate for comparison purposes. This geographic coordinate may be the center, or a corner, or some other defined place within the geospatial shape. Since the postal code and the property boundary are not identical shapes, the geographic coordinate assigned to each shape may not be equal even though the geospatial shapes of the two areas overlap. Thus, documents associated with the postal code may not be properly associated with the property boundary.

Due to the large amount of documents that must be searched and the problems associated with finding the geospatial location data in each document, due diligence searches may be costly, time consuming, and still be ineffective in finding many important documents as a result of a due diligence search. Some real estate decisions are based on time sensitive proposals and are analyzed based on the time needed to conduct due diligence. With improved searching, sorting, and organization, the various embodiments permit the user to speed up the due diligence process, providing a tremendous benefit for time sensitive transactions.

Further, geospatial tags are able to identify the extents of the entire shape of the geospatial location associated with a document. Thus, documents with overlapping areas may be quickly identified and associated with both geospatial locations. For instance, documents for a piece of real estate only partially enclosed within a postal code may be found in a search of all documents linked to the postal code. All geospatial locations have a shape. For instance, a road may be made up of line segments and open arcs. A plot of land may be a circle, a polygon, an oval, or a mix of shapes. Country, state, county, city, and postal code boundaries may be made up of a complex mix of line segments and arc segments enclosing an area. The various embodiments are capable of representing complex shapes associated with geospatial locations. A tremendous amount of location data and accuracy of information is lost when representing complex geospatial shapes by designating a single geographic coordinate to indicate the shape's location. This is also true when an area is defined by reducing the accuracy of the geographic coordinate such that the area covered is dependent on the loss of accuracy of the geographic coordinate defined by the geospatial tag. While the various embodiments are capable of representing a single point on a map, the embodiments may also define the true extent of the geospatial shape. Maintaining the complete information of the geospatial shape ensures that searches, sorts, and other logical algorithms are capable of fully relating and differentiating documents linked with different geospatial shapes. A geospatial shape also permits additional elements to be associated with a location. For instance, the addition of a height/elevation element permits the geospatial shape to represent three dimensional geospatial locations. The addition of a date and time element allows for a number of possible uses, such as designating the date of sale of real estate, designating the date of surveying of a plot of land, designating the last time natural disasters or other events occurred on or around a location, and many more possibilities. The user may add additional elements as necessary to meet the demands of identifying, searching, and sorting electronic documents linked with geospatial tags.

The foregoing description of the invention has been presented for purposes of illustration and description. It is not intended to be exhaustive or to limit the invention to the precise form disclosed, and other modifications and variations may be possible in light of the above teachings. Embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of searching electronic files comprising:
obtaining geospatial location data relating to a location of interest;
converting said geospatial location data into a range of geospatial coordinate search points;
searching geospatial tags linked with said electronic files for said range of geospatial coordinate search points, said geospatial tags storing geospatial shape data for each of said electronic files linked to each of said geospatial tags, each of said geospatial tags delineating a geospatial shape associated with each of said electronic files using at least two elements, a shape element and a geospatial coordinate element, said shape element defining said shape of said geospatial shape data, and said geospatial coordinate element defining said geospatial coordinates of said geospatial shape data;
identifying found electronic files, said found electronic files being a subset of said electronic files wherein said geospatial tags linked to said electronic files contain at least one geospatial coordinate search point of said range of geospatial coordinate search points;
retrieving said found electronic files; and
delivering said found electronic files to a user.

2. The method of claim 1 wherein said range of geospatial coordinate search points comprises a single geospatial coordinate search point.

3. The method of claim 1 further comprising storing said found electronic files on an archival data storage system.

4. The method of claim 1 further comprising moving said found electronic files to a desired electronic storage location from an original delivery location.

5. The method of claim 1 further comprising sorting said found electronic files based on elements of said geospatial tags associated with each of said found electronic files.

6. The method of claim 5 wherein said elements of said geospatial tags used for sorting said electronic files are comprised of at least one of: size of an area defined by said geospatial tags, date and time defined by said geospatial tags, height defined by said geospatial tags, and type of shape of said geospatial tags.

7. The method of claim 1 wherein said geospatial location data is comprised of at least one of the group consisting of: a street address; latitude and longitude coordinates; Universal Transverse Mercator (UTM) coordinates; county; postal code; parcel; tract, lot and block; and township, range and section.

8. The method of claim 1 wherein said step of obtaining said geospatial location data further comprises a user manually entering said geospatial location data.

9. The method of claim 1 wherein said step of obtaining said geospatial location data further comprises:
a user drawing a shape on a digital map using a drawing tool; and
converting said shape into said geospatial location data.

10. The method of claim 1 wherein said step of obtaining said geospatial location data further comprises:
a user drawing a shape on a digital image using a drawing tool; and
converting said shape into said geospatial location data.

11. The method of claim 1 wherein said step of obtaining said geospatial location data further comprises:
a user entering metes and bounds data using a metes and bounds tool; and
converting said metes and bounds data into said geospatial location data.

12. The method of claim 1 wherein said step of obtaining said geospatial location data further comprises:
a user entering latitude and longitude data using a table of latitude and longitudes tool; and
converting said latitude and longitude data into said geospatial location data.

13. The method of claim 1 wherein said step of obtaining said geospatial location data further comprises:
a user entering Global Positioning System (GPS) data using a GPS field entry tool; and
converting said GPS data into said geospatial location data.

14. The method of claim 1 wherein said step of delivering said found electronic files delivers said found electronic files in a format comprising at least one of the group consisting of: a list of said found electronic files, copies of said found electronic files, and said found electronic files opened on a land web site.

15. The method of claim 1 wherein said electronic file is comprised of at least one of the group consisting of: e-documents, digital images, digital photos, and digital maps.

16. The method of claim 15 wherein said e-documents is comprised of at least one of the group consisting of: Contract and Pre-closing Documents, Letter of Intent, Contract to Buy and Sell Real Estate, Agreement to Amend/Extend, Contract Assignment, Contract Addenda, Lead-Based Paint Disclosure, Inspection Notice, Brokerage Disclosure, Seller's Property Disclosure, Counterproposal, Earnest Money Promissory Note, Conveyance Documents, General/Special Warranty Deeds, Quit Claim Deeds, Bill of Sale, Water Stock Assignments, Mineral Deed, Water Tap Transfers, Well Permit Transfer, Loan Documents, Deed of Trust, Promissory Note, UCC Financing Statements, Security Agreement, Credit Report, Title and Survey Documents, Title Insurance Commitment, ALTA/ACSM Land Title Survey, Tax Certificate, Closing Instructions, Statement of Settlement, Real Property Transfer Declaration, Forms DR-1083, Agreement for Taxes, Utility Agreement, Closing Confirmation for 1099 Reporting, Title Insurance Owner's Policy, Title Insurance Lender's Policy, Organization and Authority Documents, Articles of Organization, By-Laws, Operating Agreement, Certificate of Good Standing, Resolutions/Unanimous Consents, Power of Attorney (Real Estate) Documents, Due Diligence Documents, Architectural Drawings, As-Built Building Plans, Building Inspection, Compliance Checks, Constraints Analysis, Construction Design Documents, Endangered Species Reports, Existing Deed of Trust, Geology Studies, Guarantees/Warrantees, Hydrology Studies, Land Plans, Leases, Market Feasibility Studies, Mining Reports, Oil and Gas Leases, Permits and Licenses, Personal Property Inventory, Phase 1 Environmental Studies, Phase 2 Environmental Studies, Property Insurance, Service and Maintenance Contracts, Sketch Plans, Soils Reports, Traffic Studies, Utilities, Wetlands Studies, Wildlife Studies, Zoning Maps, and Zoning Regulations.

17. The method of claim 1 wherein said shape element comprises at least one of the group consisting of: point, line, open arc, polygon, oval, circle and closed arc.

18. The method of claim 1 wherein said geospatial coordinate element comprises a set of points, said set of points combining with said shape element to define an extent of said geospatial location.

19. The method of claim 18 wherein each of said range of geospatial coordinate search points and each of said set of points are comprised of an x coordinate and a y coordinate as defined by a geographic coordinate system.

20. The method of claim 19 wherein said geographic coordinate system comprises at least one of the group consisting of: latitude/longitude coordinates, and Universal Transverse Mercator (UTM) coordinates.

21. The method of claim 18 wherein each of said range of geospatial coordinate search points and each point of said set of points are comprised of a latitude coordinate value and a longitude coordinate value.

22. The method of claim 21 wherein each of said range of geospatial coordinate search points and each of said set of points further comprise a height value.

23. The method of claim 22 wherein said height value is measured using a measurement unit comprised of at least one of the group consisting of: meters, kilometers, feet, yards, and miles.

24. The method of claim 22 wherein said extent of said geospatial location comprises a three dimensional volume.

25. The method of claim 18 wherein each of said range of geospatial coordinate search points and each of said set of points further comprise a date and time value.

26. The method of claim 18 wherein said set of points define a point shape such that said set of points comprises a single point delineating said point shape.

27. The method of claim 18 wherein said set of points define a line shape such that said set of points comprises two points, a start point delineating a start of said line shape and an end point delineating an end of said line shape, wherein said extent of said geospatial location comprises a range of geospatial points delineating said line shape.

28. The method of claim 27 further comprising a set of additional points comprised of at least one additional point, wherein said set of additional points delineates a corner of said line shape such that said line starts at said start point and is straight line connected to each of said additional points in order, and said line ends when a last point of said additional points is straight line connected to said end point of said line shape.

29. The method of claim 18 wherein said set of points define an open arc shape such that said set of points comprises a center point delineating a center of an oval containing said open arc shape, a start point being a first point on said oval where said open arc shape begins and an end point being a second point on said oval where said open arc shape ends, and a curving boundary line drawn following a path on said oval between said start point and said end point of said open arc shape, wherein said extent of said geospatial location comprises a range of geospatial points delineating said open arc shape.

30. The method of claim 18 wherein said set of points define a polygon shape such that said set of points comprises a start point of said polygon shape, an end point of said polygon shape, and a set of additional points comprising at least one additional point of said polygon shape, said start point of said polygon shape being straight line connected to a first point of said additional points, each of said additional points straight lined connected to a next point of said additional points until a last point of said additional points is reached, said last point of said additional points being straight line connected to said end point of said polygon shape, and said end point closing said polygon shape by being straight line connected to said start point of said polygon shape, wherein said extent of said geospatial location comprises a range of geospatial points delineating and contained within said polygon shape.

31. The method of claim 18 wherein said set of points define an oval shape such that said set of points comprises a center point of said oval shape, a first point on said oval shape, and a second point on said oval shape, said oval shape drawn such that both said first point and said second point appear on said oval shape and said center point is located at a center of said oval shape, wherein said extent of said geospatial location comprises a range of geospatial points delineating and contained within said oval shape.

32. The method of claim 18 wherein said set of points define a circle shape such that said set of points comprises a center point of said circle shape and a perimeter point located on said circle shape, said circle shape drawn such that said perimeter point appears on said circle shape and said center point is located at a center of said circle shape, wherein said extent of said geospatial location comprises a range of geospatial points delineating and contained within said circle shape.

33. The method of claim 18 wherein said set of points define a closed arc shape such that said set of points comprises a center point delineating a center of an oval containing said closed arc shape, a start point being a first point on said oval where said closed arc shape begins and an end point being a second point on said oval where said closed arc shape ends, a curving boundary line drawn following a path on said oval between said start point and said end point of said closed arc shape, a first straight line drawn from said start point to said center point, and a second straight line drawn from said end point to said center point closing said closed arc shape, wherein said extent of said geospatial location comprises a range of geospatial points delineating and contained within said closed arc shape.

34. The method of claim 18 further comprising defining multiple shapes using said set of points of a geospatial tag.

35. The method of claim 34 wherein said set of points further comprises a shape sub-element and a break sub-element, said shape sub-element defining a first shape for a first subset of points of said set of points such that said first shape is delineated by said first subset of points, said break sub-element indicating an end to a preceding shape and a start to a succeeding shape.

36. The method of claim 1 wherein said geospatial tag is included within said electronic file in a header portion of said electronic file.

37. The method of claim 1 wherein said geospatial tag is a geospatial tag file, said geospatial tag file being a separate file from said electronic file, and said geospatial tag file is linked with said electronic file.

38. The method of claim 37 wherein said geospatial tag file is linked to said electronic file by a matching base file name for said geospatial tag file and said electronic file, but using a geospatial tag file extension name for said geospatial tag file which is different from a file extension name of said electronic file.

39. The method of claim 1 wherein said geospatial tag is stored in a geospatial tag list, said geospatial tag list being a list structure that stores a file name of said electronic file that is linked with said geospatial tag.

40. The method of claim 39 wherein said geospatial tag links said geospatial tag and said electronic file by storing said geospatial tag and said file name of said electronic file in a single entry in said geospatial tag list.

41. The method of claim 39 wherein said geospatial tag list is contained in a database.

42. The method of claim 41 wherein said geospatial tag is stored in a first database entry and said file name of said electronic file is stored in a second database entry, and said first database entry and said second database entry are linked via relationship functionality of said database.

43. A search engine that searches electronic files comprising:
a geospatial location subsystem that obtains geospatial location data relating to a location of interest and converts said geospatial location data relating to said location of interest into a range of geospatial coordinate search points;
a search subsystem that searches geospatial tags linked with said electronic files for said range geospatial coordinate search points and identifies found electronic files, said found electronic files being a subset of said electronic files, wherein said geospatial tags linked to said electronic files contain at least one geospatial coordinate search point of said range of geospatial coordinate search points, each of said geospatial tags delineating geospatial shape data associated with each of said electronic files using at least two elements, a shape element and a geospatial coordinate element, said shape element defining said shape of said geospatial shape data, and said geospatial coordinate element defining said geospatial coordinates of said geospatial shape data; and
a retrieval and delivery subsystem that retrieves said found electronic files and delivers said found electronic files to a user.

44. The search engine of claim 43 wherein said range of geospatial coordinate search points comprises a single geospatial coordinate search point.

45. The search engine of claim 43 further comprising a storing subsystem that stores said found electronic files on an archival data storage system.

46. The search engine of claim 43 further comprising moving subsystem that moves said found electronic files to a desired electronic storage location from an original delivery location.

47. The search engine of claim 43 further comprising a sorting subsystem that sorts said found electronic files based on elements of said geospatial tags associated with each of said found electronic files.

48. The search engine of claim 47 wherein said elements of said geospatial tags used for sorting said electronic files are comprised of at least one of: size of an area defined by said geospatial tags, date and time defined by said geospatial tags, height defined by said geospatial tags, and type of shape of said geospatial tags.

49. The search engine of claim 43 wherein said geospatial location data is comprised of at least one of the group consisting of: a street address; latitude and longitude coordinates; Universal Transverse Mercator (UTM) coordinates; county; postal code; parcel; tract, lot and block; and township, range and section.

50. The search engine of claim 43 wherein said geospatial location data is obtained from manual entry by a user of said geospatial location data.

51. The search engine of claim 43 wherein said geospatial location data is obtained by converting a shape drawn on a digital map by a user with a drawing tool into said geospatial location data.

52. The search engine of claim 43 wherein said geospatial location data is obtained by converting metes and bounds data entered by a user with a metes and bounds tool into said geospatial location data.

53. The search engine of claim 43 wherein said geospatial location data is obtained by converting latitude and longitude data entered by a user with a table of latitude and longitudes tool into said geospatial location data.

54. The search engine of claim 43 wherein said geospatial location data is obtained by converting Global Positioning System (GPS) data entered by a user with a GPS field entry tool into said geospatial location data.

55. The search engine of claim 43 wherein said geospatial location data is obtained by converting a shape drawn on a digital image by a user with a drawing tool into said geospatial location data.

56. The search engine of claim 43 wherein said retrieval and delivery subsystem delivers said found electronic files in a format comprising at least one of the group consisting of: a list of said found electronic files, copies of said found electronic files, and said found electronic files opened on a land web site.

57. The search engine of claim 43 wherein said electronic file is comprised of at least one of the group consisting of: e-documents, digital images, digital photos, and digital maps.

58. The search engine of claim 57 wherein said e-documents is comprised of at least one of the group consisting of: Contract and Pre-closing Documents, Letter of Intent, Contract to Buy and Sell Real Estate, Agreement to Amend/Extend, Contract Assignment, Contract Addenda, Lead-Based Paint Disclosure, Inspection Notice, Brokerage Disclosure, Seller's Property Disclosure, Counterproposal, Earnest Money Promissory Note, Conveyance Documents, General/Special Warranty Deeds, Quit Claim Deeds, Bill of Sale, Water Stock Assignments, Mineral Deed, Water Tap Transfers, Well Permit Transfer, Loan Documents, Deed of Trust, Promissory Note, UCC Financing Statements, Security Agreement, Credit Report, Title and Survey Documents, Title Insurance Commitment, ALTA/ACSM Land Title Survey, Tax Certificate, Closing Instructions, Statement of Settlement, Real Property Transfer Declaration, Forms DR-1083, Agreement for Taxes, Utility Agreement, Closing Confirmation for 1099 Reporting, Title Insurance Owner's Policy, Title Insurance Lender's Policy, Organization and Authority Documents, Articles of Organization, By-Laws, Operating Agreement, Certificate of Good Standing, Resolutions/Unanimous Consents, Power of Attorney (Real Estate) Documents, Due Diligence Documents, Architectural Drawings, As-Built Building Plans, Building Inspection, Compliance Checks, Constraints Analysis, Construction Design Documents, Endangered Species Reports, Existing Deed of Trust, Geology Studies, Guarantees/Warrantees, Hydrology Studies, Land Plans, Leases, Market Feasibility Studies, Mining Reports, Oil and Gas Leases, Permits and Licenses, Personal Property Inventory, Phase 1 Environmental Studies, Phase 2 Environmental Studies, Property Insurance, Service and Maintenance Contracts, Sketch Plans, Soils Reports, Traffic Studies, Utilities, Wetlands Studies, Wildlife Studies, Zoning Maps, and Zoning Regulations.

59. The search engine of claim 43 wherein said shape element comprises at least one of the group consisting of: point, line, open arc, polygon, oval, circle, and closed arc.

60. The search engine of claim 43 wherein said geospatial coordinate element comprises a set of points, said set of points combining with said shape element to define an extent of said geospatial location.

61. The search engine of claim 60 wherein each of said range of geospatial coordinate search points and each of said set of points are comprised of an x coordinate and a y coordinate as defined by a geographic coordinate system.

62. The search engine of claim 61 wherein said geographic coordinate system comprises at least one of the group consisting of: latitude/longitude coordinates, and Universal Transverse Mercator (UTM) coordinates.

63. The search engine of claim 60 wherein each of said range of geospatial coordinate search points and each point of said set of points are comprised of a latitude coordinate value and a longitude coordinate value.

64. The search engine of claim 63 wherein each of said range of geospatial coordinate search points and each of said set of points further comprise a height value.

65. The search engine of claim 64 wherein said height value is measured using a measurement unit comprised of at least one of the group consisting of: meters, kilometers, feet, yards, and miles.

66. The method of claim 64 wherein said extent of said geospatial location comprises a three dimensional volume.

67. The search engine of claim 60 wherein each of said range of geospatial coordinate search points and each of said set of points further comprise a date and time value.

68. The search engine of claim 60 wherein said set of points define a point shape such that said set of points comprises a single point delineating said point shape.

69. The search engine of claim 60 wherein said set of points define a line shape such that said set of points comprises two points, a start point delineating a start of said line shape and an end point delineating an end of said line shape, wherein said extent of said geospatial location comprises a range of geospatial points delineating said line shape.

70. The search engine of claim 69 further comprising a set of additional points comprised of at least one additional point, wherein said set of additional points delineates a corner of said line shape such that said line starts at said start point and is straight line connected to each of said additional points in order, and said line ends when a last point of said additional points is straight line connected to said end point of said line shape.

71. The search engine of claim 60 wherein said set of points define an open arc shape such that said set of points comprises a center point delineating a center of an oval containing said open arc shape, a start point being a first point on said oval where said open arc shape begins and an end point being a second point on said oval where said open arc shape ends, and a curving boundary line drawn following a path on said circle between said start point and said end point of said open arc shape, wherein said extent of said geospatial location comprises a range of geospatial points delineating said open arc shape.

72. The search engine of claim 60 wherein said set of points define a polygon shape such that said set of points comprises a start point of said polygon shape, an end point of said polygon shape, and a set of additional points comprising at least one additional point of said polygon shape, said start point of said polygon shape being straight line connected to a first point of said additional points, each of said additional points straight lined connected to a next point of said additional points until a last point of said additional points is reached, said last point of said additional points being straight line connected to said end point of said polygon shape, and said end point closing said polygon shape by being straight line connected to said start point of said polygon shape, wherein said extent of said geospatial location comprises a range of geospatial points delineating and contained within said polygon shape.

73. The search engine of claim 60 wherein said set of points define an oval shape such that said set of points comprises a center point of said oval shape, a first point on said oval shape, and a second point on said oval shape, said oval shape drawn such that both said first point and said second point appear on said oval shape and said center point is located at a center of said oval shape, wherein said extent of said geospatial location comprises a range of geospatial points delineating and contained within said oval shape.

74. The search engine of claim 60 wherein said set of points, wherein said extent of said geospatial location comprises a range of geospatial points delineating and contained within said circle shape such that said set of points comprises a center point of said circle shape and a perimeter point located on said circle shape, said circle shape drawn such that said perimeter point appears on said circle shape and said center point is located at a center of said circle shape.

75. The search engine of claim 60 wherein said set of points define a closed arc shape such that said set of points comprises a center point delineating a center of an oval containing said closed arc shape, a start point being a first point on said oval where said closed arc shape begins and an end point being a second point on said oval where said closed arc shape ends, a curving boundary line drawn following a path on said circle between said start point and said end point of said closed arc shape, a first straight line drawn from said start point to said center point, and a second straight line drawn from said end point to said center point closing said closed arc shape, wherein said extent of said geospatial location comprises a range of geospatial points delineating and contained within said closed arc shape.

76. The software application of claim 43 wherein said geospatial tag defines multiple shapes defining multiple shapes using said set of points of a geospatial tag

77. The software application of claim 76 wherein said set of points further comprises a shape sub-element and a break sub-element, said shape sub-element defining a first shape for a first subset of points of said set of points such that said first shape is delineated by said first subset of points, said break sub-element indicating an end to a preceding shape and a start to a succeeding shape.

78. The search engine of claim 43 wherein said geospatial tag is included within said electronic file in a header portion of said electronic file.

79. The search engine of claim 43 wherein said geospatial tag is a geospatial tag file, said geospatial tag file being a separate file from said electronic file, and said geospatial tag file is linked with said electronic file.

80. The search engine of claim 79 wherein said geospatial tag file is linked to said electronic file by a matching base file name for said geospatial tag file and said electronic file, but using a geospatial tag file extension name for said geospatial tag file which is different from a file extension name of said electronic file.

81. The search engine of claim 43 wherein said geospatial tag is stored in a geospatial tag list, said geospatial tag list being a list structure that stores a file name of said electronic file that is linked with said geospatial tag.

82. The search engine of claim 81 wherein said geospatial tag links said geospatial tag and said electronic file by storing said geospatial tag and said file name of said electronic file in a single entry in said geospatial tag list.

83. The search engine of claim 81 wherein said geospatial tag list is contained in a database.

84. The search engine of claim 83 wherein said geospatial tag is stored in a first database entry and said file name of said electronic file is stored in a second database entry, and said first database entry and said second database entry are linked via relationship functionality of said database.

85. A search engine that searches electronic files comprising:
means for obtaining geospatial location data relating to a location of interest;
means for converting said geospatial location data into a range of geospatial coordinate search points;
means for searching geospatial tags linked with said electronic files for said range of geospatial coordinate search points;
means for identifying found electronic files;
means for retrieving said found electronic files; and
means for delivering said found electronic files to a user.
